(19) United States
(12) Patent Application Publication
(10) Pub. No.: US 2016/0231870 A1
(43) Pub. Date: Aug. 11, 2016

(54) SYSTEMS AND METHODS FOR COMPOSITE APPLICATIONS

(71) Applicants: Brian Summa, Salt Lake City, UT (US); Valerio Pascucci, Salt Lake City, UT (US)

(72) Inventors: Brian Summa, Salt Lake City, UT (US); Valerio Pascucci, Salt Lake City, UT (US)

(21) Appl. No.: 15/017,218

(22) Filed: Feb. 5, 2016

Related U.S. Application Data
(60) Provisional application No. 62/112,606, filed on Feb. 5, 2015.

(51) Int. Cl. G06F 3/0481; G06F 3/0487; G06F 9/54; G06F 3/0484

(52) U.S. Cl. CPC G06F 3/0481; G06F 3/04845; G06F 3/0487; G06F 9/542

(57) ABSTRACT

A generalized application coordination module coordinates execution of two or more general-purpose applications. Native display elements of the applications may be arranged in a composite application interface. Inputs and/or events pertaining to the composite application may be directed to respective applications. Operations to configure the application(s) of a composite application may be recorded and/or replayed as macro scripts, which may be triggered by specified workflow actions.

### CROSS-REFERENCE TO RELATED APPLICATIONS

The Application Data Sheet (“ADS”) filed in this application is incorporated by reference herein. Any applications claimed on the ADS for priority under 35 U.S.C. §§119, 120, 121, or 365(c), and any and all parent, grandparent, great-grandparent, etc., applications of such applications, are also incorporated by reference, including any priority claims made in those applications and any material incorporated by reference, to the extent such subject matter is not inconsistent herewith. This application claims the benefit of U.S. Provisional Patent Application No. 62/112,606 filed Feb. 5, 2015, which application is incorporated by reference to the extent such subject matter is not inconsistent herewith.

### STATEMENT REGARDING FEDERALLY SPONSORED RESEARCH

This invention was made with government support through National Science Foundation and Department of Energy under the following grants: NSF OCI0906379, DOE 120341, DOE DESC0006872, DOE, DESC0001922, DOE DEEE0004449, DOE P01180734, DOE DESC0007446, NTNL 0904631, and DOE/LLNL B597476.

### TECHNICAL FIELD

This disclosure pertains to application coordination and, in particular, to systems and methods for managing composite and/or aggregate applications.

### BACKGROUND

Computer applications and/or tools are typically designed to meet the needs of a group of “target users.” Such tools may be designed to implement a particular set of features and/or functionality needed by the target users. Due to size and complexity limitations, functionality that is not typically needed by the target users of an application may not be supported and/or implemented in the application. Therefore, an application may be effective for performing certain tasks, but may be ill-suited for others. For example, visualization applications (e.g., the Visualization Toolkit VTK) may provide powerful graphics capabilities, but may lack the numerical processing and/or analytical capabilities of dedicated technical computing environments, such as MATLAB(™), MATHEMATICA(™), and the like. It may be desirable to combine the functionality of different applications and/or toolkits, but it may be impractical to customize the applications to enable them to work together in an efficient, seamless manner.

In some cases, a user may generate data using a first application, convert the data into a portable format, and pass the converted data to a second, different application. This approach to integration, however, can be inefficient and error prone. Alternatively, application integration may be facilitated by dedicated Application Programming Interfaces (APIs) of the respective applications and/or toolkits (an application coordination facility). Although these APIs can be powerful, they are typically specific to certain applications (and/or classes of applications) and, as such, cannot be used generally. Moreover, like the applications themselves, integration APIs may implement a particular set of features and/or functionality that is not suitable for all users. Even with access to dedicated integration APIs, the complexity of application integration is outside of the skillset of even more technically minded users.

### BRIEF DESCRIPTION OF THE DRAWINGS

The disclosure references the following drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the scope of the subject matter presented herein.

FIG. 1A is a schematic block diagram of one embodiment of a system for managing composite applications;

FIG. 1B depicts one embodiment of a composite application;

FIG. 1C depicts another embodiment of a composite application;

FIG. 2 is a schematic block diagram of another embodiment of a system for managing composite applications;

FIG. 3 is a schematic block diagram of another embodiment of a system for managing composite applications;

FIG. 4A depicts embodiments of metadata pertaining to a composite application;

FIG. 4B depicts further embodiments of metadata pertaining to a composite application;

FIG. 5A depicts embodiments of a composite application;

FIG. 5B depicts further embodiments of a composite application;

FIG. 5C depicts further embodiments of a composite application;

FIG. 5D depicts further embodiments of a composite application;

FIG. 6 is a flow diagram of one embodiment of a method for managing a composite application;

FIG. 7 is a flow diagram of another embodiment of a method for managing a composite application;

FIG. 8 is a flow diagram of another embodiment of a method for managing a composite application;

FIG. 9 is a flow diagram of another embodiment of a method for managing a composite application; and

FIG. 10 is a flow diagram of another embodiment of a method for managing a composite application.

### DETAILED DESCRIPTION

Disclosed herein are embodiments of systems, methods, apparatus, circuits, and/or interfaces for managing composite applications. The embodiments disclosed herein may be embodied as executable instructions stored on a non-transitory machine-readable storage medium. The instructions may comprise computer program code that, when executed and/or interpreted by a computing device, causes the computing device to implement the processing steps and/or operations disclosed herein. The embodiments disclosed herein may be implemented and/or embodied as a driver, a library, an interface, an application programming interface (API), firmware, Field Programmable Gate Array (FPGA) configuration data, and/or the like. Accordingly, portions of the embodiments disclosed herein may be accessed by and/or included within particular modules, processes, and/or services (e.g., incorporated within a kernel layer of an operating system, within application frameworks and/or libraries, within device drivers, in user-space applications and/or libraries, and/or the like). Alternatively, or in addition, the embodiments disclosed herein may be implemented as particular machine components, which may include, but are not limited to: circuits, processing components, special-purpose processors, general-purpose processors, interface components, hardware controller(s), programmable hardware, programmable logic elements, FPGAs, Application Specific Integrated Circuits (ASICs), and/or the like.

The embodiments disclosed herein improve the operation of a computing device by, inter alia, enabling coordination between separate, standalone applications operating on the computing device. Accordingly, the embodiments disclosed herein may provide additional functionality that does not exist in a general-purpose computing device and/or may improve the operation of the computing device by coordinating operation of general-purpose applications that do not include coordination-specific functionality. Accordingly, the embodiments disclosed herein may improve the operation of the particular applications operating on the computing device.

Disclosed herein are embodiments of an apparatus for improving the operation of a computing device by, inter alia, managing composite applications. Embodiments of the apparatus include a process management circuit configured to launch a plurality of applications within an operating environment of a computing device, the plurality of processes including a host application and a child application, wherein the host application comprises a host graphical display interface, and wherein the child application comprises a plurality of child graphical display elements, a display management circuit configured to embed a first one of the plurality of child graphical display elements within the host graphical display interface, and/or an event handler circuit to redirect an input associated with the host graphical display interface to the child application. The display management circuit may be configured to remove one or more of the plurality of child graphical display elements.

Embodiments of the disclosed apparatus may further include an application integration module to identify an object within the host graphical display interface. The display management circuit may be configured to embed the first child graphical display element within the identified object. Embedding the first child graphical display element may comprise fitting the first graphical display element to the object within the host graphical display interface. Fitting the first graphical display element may include one or more of cropping the first graphical display element, scaling the first graphical display element, positioning the first graphical display element, and morphing the first graphical display element.

The display management circuit of the disclosed apparatus may be configured to embed an extended graphical display element within the host graphical display interface that is separate from graphical display elements of the host application and from the plurality of child graphical display elements. The event handler circuit may be configured to direct a message pertaining to the extended graphical display element to one or more of the host application and the child application. The event handler circuit may be configured to capture a message pertaining to one of a graphical interface element of the host application, a graphical interface element of the child application, and the extended graphical interface element and to issue a corresponding message to both the host application and the child application. Issuing the corresponding message to the host application may include one of formatting the message and translating the message for use by an event handler of the host application.

Disclosed herein are embodiments of a system to improve the operation of a computing system by, inter alia, managing application coordination. Embodiments of the disclosed system include a computing system comprising a display device and a user input device, and a macro engine to execute a first macro script associated with a composite application on the computing system, wherein executing the first macro script comprises, invoking a plurality of applications by use of an application framework of the computing system, forming a graphical user interface of the composite application by use of native graphical user interface elements of the plurality of applications, displaying the graphical user interface of the composite application on the display device of the computing system, and issuing a plurality of computer system messages to the plurality of applications by use of the application framework, wherein the computer system messages are configured to place the plurality of applications into a particular state. In some embodiments, executing the second macro script comprises adapting the native graphical user interface element of the first application in accordance with the particular shape within the native graphical user interface element of the second application.

The system may further include a workflow manager to configure the macro engine to execute a second macro script associated with the composite application in response to a trigger condition associated with the second macro script, wherein executing the second macro script comprises embedding a native graphical user interface element of a first one of the applications into a native graphical user interface element of a second one of the applications.

Embodiments of the disclosed system include an application integration module to detect the trigger condition associated with the second macro script by use of an application-specific interface of the second application. The application integration module may be configured to detect the trigger condition by use of an application coordination object of the second application. The trigger condition may correspond to display of a particular shape within the native graphical user interface element of the second application.

In some embodiments, the system includes a recorder module to capture computer system messages configured to place the plurality of applications into the particular state in response to manipulation of the user input device of the computing system. The system may further include a computer system message handler to direct computer system messages pertaining to the composite application to one or more of the plurality of applications. The computer system message handler may be configured to split a first message, such that the first message is issued to two or more of the plurality of applications. The computer system message handler may be further configured to capture a message pertaining to a first one of the plurality of applications and to issue the captured message to a second one of the plurality of applications.

Disclosed herein are embodiments of a method for improving the operation of a computing system by, inter alia, managing composite applications. The method may include launching a host application within an application framework of a computing system, the host application having a host graphical user interface, and issuing a sequence of computer system messages to the host application through the application framework, wherein the sequence of computer system messages is configured to emulate user interaction with the host application.

Embodiments of the method further include launching a child application on the computing system, the child application having a child graphical user interface comprising a plurality of native graphical user interface elements, issuing a sequence of computer system messages to the child application through the application framework, wherein the sequence of computer system messages is configured to embed one of the native graphical user interface elements of the child application into the host graphical user interface, and displaying a composite application interface comprising the native graphical user interface of the child application embedded within the host graphical user interface on a display device of the computing system in response to detecting a trigger condition pertaining to the host application. The method may further include capturing messages corresponding to the host graphical user interface and/or identifying captured messages to direct to the child application.

In some embodiments, the method further comprises embedding an extended graphical user interface element within the host graphical user interface, wherein the extended graphical user interface element is separate from native graphical user interface elements of the host application and the native graphical user interface elements of the child application, capturing messages pertaining to the extended graphical user interface element, and identifying captured messages pertaining to the extended graphical user interface element to one or more of the host application and the child application.

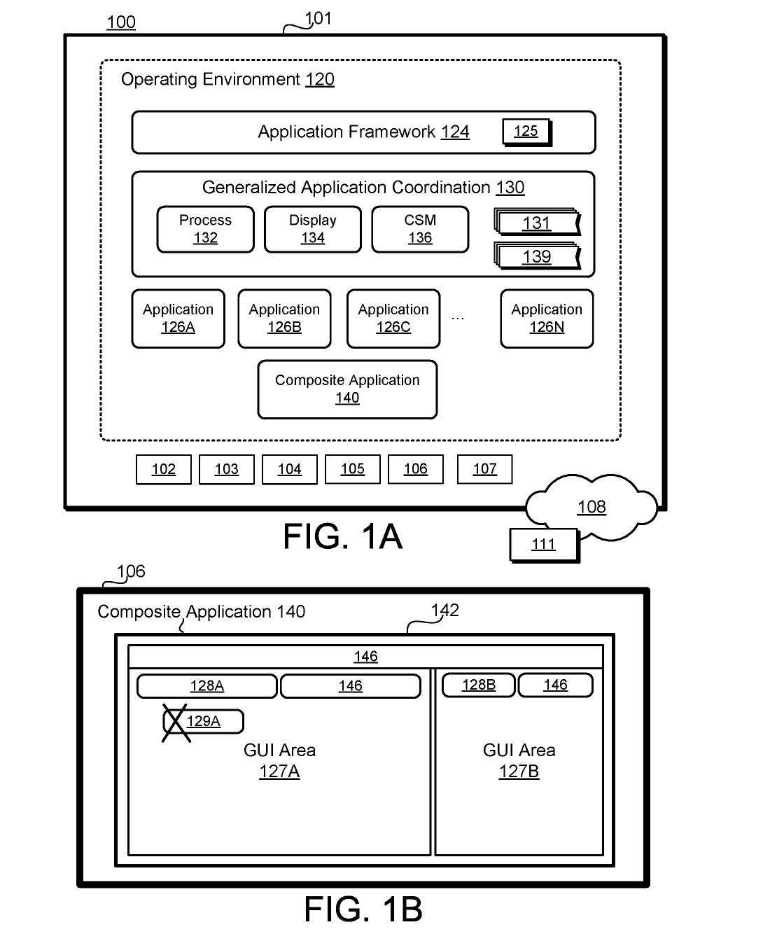

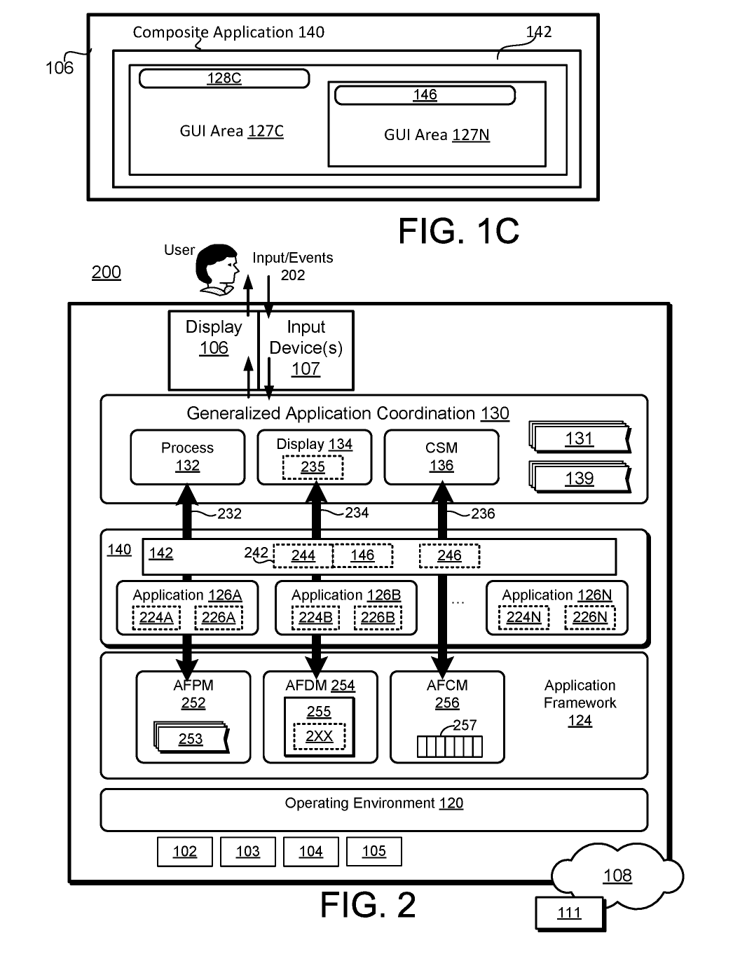

FIG. 1A is a block diagram of one embodiment of a system 100 for application coordination. The system 100 of FIG. 1A may include a computing system 101, which may comprise one or more of a personal computer, a desktop, a workstation, a server, a mainframe, a node, a cluster (e.g., a plurality of interconnected computing devices), a portable computing device, a personal computing device, a communication device (e.g., a smart phone), and/or the like. Accordingly, although illustrated as a single element, the computing system 101 may comprise and/or consist of a plurality of separate computing devices and/or components. The computing system 101 may comprise processing resources 102, memory resources 103, storage resources 104, a communication interface 105, human-machine interface (HMI) components, including a display 106, input device(s) 107, and/or the like.

The processing resources 102 of the computing system 101 may include, but are not limited to, processing modules, circuits, general-purpose central processing units (CPUs), application-specific integrated circuits (ASICs), and programmable logic elements, such as field programmable gate arrays (FPGAs), programmable logic arrays (PLAs), and/or the like. The memory resources 103 may include random-access memory (RAM), such as dynamic RAM (DRAM), cache memory (e.g., processor cache), disk cache, and/or the like. The storage resources 104 may comprise one or more storage device(s) comprising non-transitory, computer-readable media, such as one or more hard disks, optical storage drives, solid-state storage devices (e.g., flash storage device(s)), logical storage resources, virtual storage resources, network attached storage resources, and/or the like.

The communication interface 105 may be configured to communicatively couple the computing system 101 to a network 108. The network 108 may comprise any suitable communication network, including, but not limited to, a Transmission Control Protocol/Internet Protocol (TCP/IP) network, a Local Area Network (LAN), a Wide Area Network (WAN), a Virtual Private Network (VPN), or a Storage Area Network (SAN).

The HMI components of the computing system 101 may include, but are not limited to: a display 106, input devices 107, such as keyboards, pointers, cameras, audio capture devices, output components, such as visual display device(s), monitors, audio output device(s), speakers, haptic output devices, and so on.

The computing system 101 may comprise an operating environment 120 configured to manage resources of the computing system 101, such as the processing resources 102, memory resources 103, storage resources 104, and so on. The operating environment 120 may comprise a bare-metal operating system configured to manage hardware components of the computing system 101. Alternatively, the operating environment 120 may comprise a virtual operating system (e.g., guest operating system) within a virtualization environment, such as a hypervisor, virtualization kernel, and/or the like. In such embodiments, the processing resources 102, memory resources 103, storage resources 104, communication interface 105, and/or the like may comprise virtual resources that are accessible through and/or managed by the virtualization environment.

The operating environment 120 may comprise an application framework 124. The application framework 124 may comprise a graphical interface environment (e.g., windowing system). In some embodiments, the application framework 124 comprises a graphical user interface (GUI) system configured to implement a WIMP (windows, icons, menus, pointer) operating environment. The application framework 124 may be configured to manage display areas and/or interfaces presented through the HMI components of the computing system 101. In some embodiments, the application framework 124 manages respective application windows comprising display and/or input elements. The disclosure is not limited in this regard, however, and could be adapted for use in any suitable application framework and/or environment comprising any suitable interface element(s).

The system 100 may further include applications 126A-N. One or more of the applications 126A-N may be embodied as instructions stored on a non-transitory, machine-readable storage medium, such as the storage resources 104 of the computing system 101. In some embodiments, one or more of the applications 126A-N are remote applications configured for execution on a separate, remote computing device 111 that is communicatively coupled to the computing system 101 through the network 108 and/or other communication mechanism. Such applications 126A-N may be embodied as instructions and/or modules stored on non-transitory storage resources of the remote computing device 111. The application 126A-N may leverage the application framework 124 to display and/or manage respective GUI elements. As used herein, a GUI element refers to one or more of: a window, a window frame, a menu, a display area (e.g., a pane, panel, canvas, and/or the like), input elements (e.g., text input areas, buttons, sliders, combo boxes, and so on), and/or the like. In some embodiments, the applications 126A-N are independently operable within separate respective memory spaces and/or program libraries managed by the operating environment 120 and/or application framework 124. The application framework 124 may allow users to designate an active application 126A-N on the computing system 101 (e.g., designate application focus). The designation of an active application 126A-N may comprise selecting a foreground window corresponding to the application 126A-N, hovering a pointer over a window corresponding to the application 126A-N, and/or the like.

In some embodiments, the application framework 124 may implement a hierarchical GUI framework that organizes windows (and/or other GUI elements) based on parent-child relationships. An application 126A-N may, for example, comprise a parent window and one or more child windows. Child windows may inherit attributes of corresponding parent windows, such as display attributes and/or the like. Computer system messages pertaining to the application 126A-N may be directed to and/or captured by the parent window of the application 126A-N, which may, in turn, direct the messages to corresponding child windows by use of, inter alia, the application framework 124.

In some embodiments, the application framework 124 comprises an application coordination facility (ACF) 125 configured to manage coordination between certain applications 126A-N, such as data sharing, embedded objects, and/or the like. The ACF 125 may include, but is not limited to: one or more libraries, interfaces, and/or extensions for coordinating application execution, such as for example, an Object Linking and Embedding (OLE) interface, OLE control extension (OCX) interfaces, Component Object Model (COM) interfaces, Cross Platform COM (XPCOM) interfaces, and/or the like. Although the ACF 125 may enable certain coordination functionality, the AFC 125 may be limited to use with applications 126A-N that implement and/or support compatible coordination interfaces. Moreover, the coordination functionality provided through the ACF 125 may be limited and/or intended for use in a particular set of scenarios and, as such, may not provide features required for certain use cases.

The computing system 101 may further comprise a generalized application coordination (GAC) module 130 configured to, inter alia, implement generalized application aggregation and/or coordination functionality within the system 100. The GAC module 130 disclosed herein may be embodied as instructions stored on a non-transitory storage medium (e.g., storage resources 104). The instructions comprising the GAC module 130 may be executable and/or interpretable by the processing resources 102 of the computing system 101. Portions of the GAC module 130 (and/or components thereof) may be embodied as and/or implemented by use of hardware components. In some embodiments, the GAC module 130 (and/or the modules thereof) comprises a circuit, which may include, but is not limited to: a special-purpose processor, an ASIC, a programmable logic element (e.g., FPGA, PLA, etc.), and/or the like.

The GAC module 130 may be configured to define, manage, and/or implement composite applications, such as composite application 140. As used herein, a “composite application” refers to an application that combines features and/or functionality of two or more different, independent applications 126A-N by use of the GAC module 130. The GAC module 130 may be configured to combine two or more applications 126A-N into a composite application 140 regardless of whether the two or more applications 126A-N implement, support, and/or conform to a particular application coordination interface, such as the ACF 125.

In some embodiments, portions of the GAC module 130 (and/or the modules, engines, and/or components thereof) are embodied as machine components, such as general and/or application-specific devices, including, but not limited to: circuits, integrated circuits, machines, components, processing components, interface components, hardware controller(s), programmable hardware, FPGAs, ASICs, and/or the like. Accordingly, the GAC module 130 disclosed herein (and/or modules, engines, and/or components thereof) may be referred to as circuits, machines, components, processing components, and/or the like. Therefore, in some embodiments, the GAC module 130 (and/or the modules, engines, and/or components thereof) may be referred to as a GAC circuit 130, GAC machine 130, and/or the like.

In some embodiments, the GAC module 130 comprises a virtualization environment to enable low-level control over applications 126A-N. The GAC module 130 may be deployed between the application(s) 126A-N (and/or composite application 140) and the application framework 124 to a) manage processes (e.g., applications 126A-N) comprising the composite application 140), b) manage display of GUI elements of the composite application 140, and/or c) manage computer system messages pertaining to the composite application 140. As used herein, a “computing system message” (CSM) refers to electronic information pertaining to an action or occurrence detected within the computing system 101. CSM may be issued by the application framework 124 and/or operating environment 120 in response to user interaction with user interface elements (e.g., GUI elements) and may include, but are not limited to: keyboard inputs and/or events, menu inputs and/or events, pointer inputs and/or events, mouse inputs and/or events, touch inputs and/or events, audio inputs and/or events, document object model (DOM) inputs and/or events, and/or the like. CSM may also refer to system-level occurrences, such as system-level inputs, events, interrupts, exceptions, signals and/or the like.

The GAC module 130 may be further configured to intercept, process, record, augment, and/or automate user interactions and/or events to seamlessly coordinate execution of two or more applications 126A-N comprising a composite application 140.

The GAC module 130 may comprise a process manager 132 configured to selectively invoke applications 126A-N on the computing system 101 and/or remote computing device 111. The process manager 132 may be configured to instantiate applications 126A-N by use of the application framework 124, operating environment 120, and/or the like. The GAC module 130 may be configured to instantiate and/or access applications 126A-N operating on the remote computing device 111 using one or more remote execution interfaces and/or APIs including, but not limited to: a Remote Procedure Call (RPC) interface, Remote Method Invocation (RMI), a Simple Object Access Protocol (SOAP) interface, and/or the like.

The process manager 132 may be further configured to maintain application state metadata 131 pertaining to the composite application 140 and/or applications 126A-N comprising the composite application 140. The application state metadata 131 may include, but is not limited to: process identifier corresponding to the applications 126A-N invoked by the process manager 132, process handles, GUI metadata (e.g., application title, window identifier, window handle, window position, size, orientation, focus, and so on), input and/or event handles and/or queues corresponding to the applications 126A-N, metadata pertaining to application coordination objects of the applications 126A-N (ACOS, as disclosed in further detail herein), metadata pertaining to data sharing facilities of the application framework 124 (e.g., clipboard contents, memory mapped file contents, etc.), file handles used by the applications 126A-N, and so on. The process manager 132 may be further configured to manage application execution, which may comprise instantiating one or more applications 126A-N, suspending one or more applications 126A-N, terminating one or more applications 126A-N, and so on.

The GAC module 130 may further comprise a display manager 134 configured to manage a display interface (GUI) of the composite application 140. The display manager 134 may be configured to construct an interface for the composite application 140 by use of GUI elements of the applications 126A-N comprising the composite application 140. The display manager 134 may be configured to manipulate GUI elements of the application(s) 126A-N, by one or more of: moving GUI elements, resizing GUI elements, embedding GUI elements within one or more other GUI elements, adding GUI elements, removing GUI elements, cropping GUI elements, scaling GUI elements, morphing GUI elements, processing GUI elements, applying effects to GUI elements (e.g., image processing, filtering, scaling, and so on), overlaying GUI elements (e.g., combining GUI elements with varying levels of transparency and/or opacity), and/or the like. The display manager 134 may be further configured to combine GUI elements of two or more different applications 126A-N into a single GUI interface (e.g., the interface of a composite application 140). In one embodiment, the display manager 134 comprises and/or references one or more image processing libraries to process display element(s) of the applications 126A-N, as disclosed herein.

The display manager 134 may be further configured to manage additional, custom GUI elements for the composite application 140. The custom GUI elements may not be provided by the applications 126A-N comprising the composite application 140. Accordingly, the composite application 140 may comprise GUI elements of the two or more applications 126A-N as well as additional GUI elements not included in the two or more applications 126A-N. The display manager 134 may generate additional GUI elements for the composite application 140 by use of the application framework 124 and/or other API, library, and/or toolkit.

The GAC module 130 may comprise a CSM manager 136 to handle CSM pertaining to the composite application 140, which may include, but is not limited to: inputs and/or events corresponding to the two or more applications 126A-N comprising the composite application 140, inputs and/or events corresponding to custom GUI elements of the composite application 140, and so on. The CSM manager 136 may be configured to monitor and/or intercept CSM associated with the applications 126A-N comprising the composite application 140. In one embodiment, the CSM manager 136 is configured to operate as an intermediary for CSM pertaining to the composite application 140 and/or applications 126A-N comprising the composite application 140. The CSM manager 136 may be configured to: a) receive CSM corresponding to composite application 140; b) determine the application 126A-N to which the received CSM is directed; and c) pass information corresponding to the CSM to the application 126A-N. In some embodiments, the CSM manager 136 is further configured to process and/or modify CSM. In one embodiment, the CSM manager 136 captures CSM pertaining to a custom GUI element and directs the CSM and/or CSM corresponding to the captured CSM to one or more applications 126A-N. The CSM manager 136 may be further configured to re-issue CSM pertaining to a first application 126A to a second application 126B (e.g., by issuing another, separate CSM and/or modifying the captured CSM). The re-issued CSM may be modified to include information pertaining to the second application 126B. In one embodiment, a CSM pertaining to a save input event, such as a request to save a data file pertaining to a first application 126A, may be re-issued as a CSM to reload and/or refresh a view of the data file in a second application 126B. In another embodiment, the CSM manager 136 receives CSM associated with custom GUI elements of the composite application 140 and re-issues corresponding CSM to one or more of the applications 126A-N and/or handles the CSM using a custom CSM handler of the composite application 140. The CSM manager 136 may be configured to modify CSM by one or more of reformatting data of the CSM, readdressing the CSM, redirecting the CSM, augmenting the CSM with additional information (e.g., information pertaining to other inputs and/or events), filtering information from the CSM (e.g., removing certain data from a CSM), and so on. In one embodiment, re-issuing a CSM corresponding to a “save” request of a custom GUI element may comprise a) issuing a “save” CSM configured for a first application 126A and b) issuing another “save” CSM configured for a second application 126B. CSM may be re-issued by use of the operating environment 120 and/or application framework 124. Alternatively, or in addition, CSM may be provided directly to a CSM handler of one or more of the applications 126A-N and/or a CSM handler facility of the composite application 140.

FIG. 1B depicts further embodiments of a composite application 140. The composite application 140 of FIG. 1B may comprise GUI display elements of two (or more) applications 126A-N combined in a composite application interface 142. The composite application interface 142 of FIG. 1B may be presented to a user by use of the display device(s) 106 of the computing system 101. The composite application interface 142 may comprise one or more GUI elements, such as a window as illustrated in FIG. 1B. The composite application interface 142 may comprise a GUI area 127A of application 126A and a GUI area 127B of application 126B. The GUI areas 127A and 127B may comprise respective GUI display elements of the respective applications 126A and 126B, which may include, but are not limited to: a framework element, window, panels, panes, client areas, controls, inputs, and/or the like. The GUI areas 127A and 127B may be generated by, inter alia, invoking instances of the respective applications 126A and 126B by use of the process manager 132, and combining GUI areas 127A and 127B into the composite application interface 142 by use of the display manager 134. The display manager 134 may be configured to combine GUI areas 127A and 127B using any suitable technique and/or mechanism. Although FIG. 1B depicts GUI areas 127A and 127B combined in a side-by-side arrangement within the composite application interface 142, the disclosure is not limited in this regard and could be adapted to arrange and/or overlay GUI areas 127A and/or 127B in any suitable combination (e.g., overlay, transparent overlay, vertical stack, embedding, and/or the like).

FIG. 1C depicts another embodiment of a composite application 140 comprising applications 126C and 126N. The composite application 140 of FIG. 1C includes a composite application interface 142, which incorporates a GUI area 127C of application 126C and a GUI area 127N of application 126N. In the FIG. 1C embodiment, the display manager 134 is configured to overlay the GUI area 127N of application 126N over and/or within GUI area 127C of application 126C. The display manager 134 may be further configured to adapt the appearance of the GUI areas 127N and 127C by, inter alia, performing image processing operation(s) on the GUI areas 127N and 127C, which may include, but are not limited to: filtering, scaling, modifying contrast, modifying saturation, gamma modifications, transparency modifications, opacity modifications, and/or the like. The display manager 134 may be configured to overlay the GUI area 127N over the GUI area 127C with varying degrees of transparency and/or opacity. Referring to the FIG. 1B embodiment, the display manager 134 may be configured to adjust the colors, saturation, and/or contrast of the GUI areas 127A and/or 127B to have a common look and/or feel, enabling a more seamless interface for the composite application 140.

The applications 126A-N comprising the composite applications 140 illustrated in FIGS. 1B and 1C may include respective application GUI elements (AGUI elements) 128A-N, which may comprise any suitable application interface elements including, but not limited to: text inputs, menus, lists, drop-down lists, buttons, sliders, links, combo boxes, edit panes, audio inputs (e.g., speech recognition inputs), and/or the like. The AGUI elements 128A-N may be implemented by the respective applications 126A-N by use of the application framework 124 and/or other APIs, libraries, toolkits, and/or the like. The display manager 134 may be configured to modify one or more of the AGUI elements 128A-N incorporated into the composite applications 140. As disclosed above, such modification may include, but is not limited to: moving AGUI elements 128A-N, scaling and/or resizing AGUI elements 128A-N, repositioning particular AGUI elements 128A-N within respective GUI areas 127A-N and/or within respective composite application interfaces 142, processing the AGUI elements 128A-N (e.g., by use of an image processing library), and/or the like.

As disclosed above, the CSM manager 136 may be configured to capture, redirect, and/or process CSM pertaining to composite applications 140. The CSM may correspond to respective AGUI elements 128A-N of a composite application 140. The CSM manager 136 may be configured to: a) identify CSM pertaining to a composite application 140, and b) direct the identified CSM to a corresponding application 126A-N. The CSM manager 136 may direct CSM to an application 126A-N by use of the application framework 124 and/or operating environment 120, as disclosed herein. The CSM manager 136 may be further configured to process and/or redirect certain CSM. In some embodiments, the CSM manager 136 issues and/or reissues CSM to two or more different applications 126A-N.

The display manager 134 may be further configured to modify the AGUI elements 128A-N of the applications 126A-N comprising a composite application 140 by one or more of: removing GUI elements, cropping GUI elements, modifying the appearance of one or more GUI elements, scaling GUI elements, and/or the like. In the FIG. 1B embodiment, the display manager 134 crops and/or removes GUI elements 129A of application 126A such that the GUI elements 129A are not displayed within the composite application interface 142. The display manager 134 may cropped and/or removed by configuring the application 126A to remove the GUI elements 129A (e.g., prevent the GUI elements 129A from being rendered on the display device 106), by configuring the application 126A to render the GUI elements 129A outside of a displayable range of the display device 106, overlaying the GUI elements 129A with other GUI element(s), rendering the GUI elements 129A transparently, and/or the like. The display manager 134 may be further configured to identify the GUI elements 129A that have been removed from the application 126A. The CSM manager 136 may be configured to ignore CSM pertaining to the removed GUI elements 129A. Alternatively, or in addition, the CSM manager 136 may filter CSM pertaining to the removed GUI elements 129A by identifying CSM corresponding to the GUI elements 129A in an input/event queue of the application 126A (in the application framework 124); and filtering the CSM such that the CSM are not received by the application 126A.

The display manager 134 may be further configured to generate additional custom GUI elements 146 for one or more composite applications 140. In the FIG. 1B embodiment, the display manager 134 is configured to generate additional custom GUI elements (extended GUI elements 146), which may include GUI elements in addition to native GUI elements of the applications 126A and/or 126B. The extended GUI elements 146 may include GUI elements to provide functionality pertaining to the composite application 140, rather than individual applications 126A and/or 126B. As illustrated in FIG. 1B, the extended GUI elements 146 may be displayed in any suitable location and/or arrangement within the composite application interface 142 including, but not limited to: a general interface area, such as a title bar, menu area, and/or the like, within respective GUI areas 127A and/or 127B, within a separate GUI area (e.g., outside of and/or independent of GUI areas of applications 126A-N), and/or the like. The extended GUI elements 146 may be configured to receive CSM pertaining to the composite application 140 (e.g., applications 126A and/or 126B). The extended GUI elements 146 may include interface elements pertaining to particular applications (e.g., 126A and/or 126B), may include interface elements that pertain to the composite application as a whole (e.g., a unified “save” input), may include interface elements that extend the functionality of the applications 126A and/or 126B (e.g.,GUI elements not included within the applications 126A and/or 126B), and so on. Although FIG. 1B illustrates embodiments of extended GUI elements 146 within particular areas of the composite application interface 142, the disclosure is not limited in this regard and could be adapted to display such elements anywhere within the composite application interface 142 and/or within separate window(s) and/or interfaces.

In the FIG. 1C embodiment, the display manager 134 is configured to display AGUI elements 128C corresponding to application 126C in GUI area 127C. The display manager 134 is further configured to display extended GUI elements 146 within GUI area 127N that is embedded within GUI area 127C. In the FIG. 1C embodiment, displaying the extended GUI elements 146 may comprise overlaying the extended GUI elements 146 over GUI area 127N and/or GUI area 127C.

FIG. 2 depicts another embodiment of a system 200 for generalized application coordination. The system 200 may comprise a computing system 101, as disclosed herein. As illustrated in FIG. 2, the application framework 124 may include an application framework process manager (AFPM) 252 configured to manage processes running on the computing system 101. Although in FIG. 2 the AFPM 252 is depicted in the application framework 124, the disclosure is not limited in this regard and could be adapted to use an AFPM 252 implemented without other layers and/or modules, such as the operating environment 120 (e.g., operating system, virtual operating system, hypervisor, and/or the like). The AFPM 252 may comprise metadata 253 pertaining to processes running on the computing system 101, which may include a process identifier, process handle, process class, process executable (e.g., file(s) associated with the process), and/or the like.

The application framework 124 may further include an application framework display manager (AFDM) 254 configured to manage a display 106 of the computing system 101. In some embodiments, the AFDM 254 maintains a virtual display 255 comprising an in-memory representation of the image(s) presented on the display(s) 106 of the computing system 101. The virtual display 255 may be stored in memory resources 103 of the computing system 101, in dedicated graphics memory (e.g., in memory resources of a graphics adapter of the computing system 101), and/or the like. The virtual display 255 may comprise display interfaces and/or GUI elements of one or more applications 126A-N running within the operating environment 120.

The application framework 124 may further include an application framework CSM manager (AFCM) 256 configured to manage CSM within the application framework 124 and/or operating environment 120. As disclosed above, CSM may correspond to user interactions with HMI components of the computing system 101, such as the input device(s) 107, which may include, but are not limited to: pointer inputs, mouse inputs, audio inputs, text inputs, keyboard inputs, and/or the like. The CSM may pertain to particular GUI elements displayed on the display device(s) 106 of the computing system 101 and managed by the application framework 124 (e.g., particular applications 126A-N). The AFCM 256 may be configured to direct CSM to respective application(s) by use of a messaging facility 257. The messaging facility 257 may comprise one or more of a message pipe, message stack, message queue, input pipe, input stack, input queue, event pipe, event stack, event queue, and/or the like. Accordingly, the messaging facility 257 may be configured to direct CSM to applications 126A-N as queued messages, non-queued messages, system messages, and/or the like. Although FIG. 2 depicts particular embodiments of an application framework 124 comprising an AFPM 252, AFDM 254, and AFCM 256, the disclosure is not limited in this regard and could be adapted for use in any operating environment 120 comprising any suitable application framework 124.

The GAC module 130 may be configured to manage a composite application 140, as disclosed herein. The composite application 140 depicted in FIG. 2 may comprise applications 126A-N. The applications 126A-N comprising the composite application 140 of FIG. 2 may be configured to generate respective native GUI elements 224A-N. The native GUI elements 224A-N may comprise a stand-alone GUI interface for the respective applications 126A-N. The applications 126A-N may be configured to generate and/or manage native GUI elements 224A-N by use of the application framework 124 (e.g., AFDM 254) and/or operating environment 120. The native GUI elements 224A-N of an application 126A-N may include but are not limited to: GUI display areas, windows (e.g., window header, window frame, window title bar, window menu, display surfaces, panels, panes, and so on), input elements, and so on. Accordingly, the native GUI elements 224A-N may include respective GUI areas 127A-N and/or AGUI elements 128A-N, disclosed above in conjunction with FIGS. 1B and 1C. The native GUI elements 224A-N may correspond to interfaces, toolkits, widgets, and/or libraries of the application framework 124 and/or operating environment 120 (e.g., a windowing framework, as disclosed herein).

The applications 126A-N may further include native CSM handlers 226A-N configured to manage CSM pertaining to the respective native GUI elements 224A-N of the applications 126A-N. The native CSM handlers 226A-N may be configured to handle CSM corresponding to the native GUI elements 224A-N of the applications 126A-N (e.g., CSM generated in response to user manipulation of one or more of the native GUI elements 224A-N). The native CSM handlers 226A-N may be adapted to handle any type of input and/or event including, but not limited to: system inputs and/or events corresponding to native GUI elements 224A-N of the application 126A-N, inputs and/or events corresponding to application objects (disclosed in further detail herein), and/or the like. The native CSM handlers 226A-N may be configured to receive inputs and/or events issued by the application framework 124 (e.g., AFCM 256) and/or operating environment 120.

The applications 126A-N comprising the composite application 140 may be configured to operate as separate, independent, standalone applications within the operating environment 120. An application 126A may operate in a conventional, stand-alone configuration in response to being executed by the processing resources 102 of the computing system 101 and/or being loaded into the memory resources 103 of the computing system 101 (e.g., in response to a user request). The application 126A may be configured to generate native GUI elements 224A-N on the display device(s) 106 of the computing system 101 by issuing native GUI requests to the application framework 124. As used herein, a “native GUI request” refers to a request, interface call, method invocation, and/or other interaction pertaining to native GUI elements 224A-N of an application 126A-N. The native GUI requests issued by the application 126A may configure the AFDM 254 to display the native GUI elements 224A on the display device(s) 106 of the computing system 101. The application 126A may be further configured to manage CSM by use of the native CSM handler 226A.

The GAC module 130 may improve the operation of the computing system 101 by, inter alia, enabling coordination between separate, standalone applications 126A-N in a composite application 140. Accordingly, the GAC module 130 disclosed herein may provide additional functionality that does not exist in a general-purpose computing system 101. The GAC module 130 may further improve operation of the computing system 101 by coordinating operation of general-purpose applications 126A-N, that do not include coordination-specific functionality. Accordingly, the GAC module 130 may improve and/or extend the operation of the applications 126A-N operating on the computing system 101.

The composite application 140 may include portions of the native GUI elements 224A-N and/or native CSM handlers 226A-N. As disclosed above, the configuration of the composite application 140 may be defined in composite application metadata 139. The composite application metadata 139 may a) specify the applications 126A-N comprising the composite application 140, b) specify the configuration of an interface of the composite application 140 (e.g., specify the combination of native application elements 224A-N), c) define additional GUI elements for the composite application 140 (e.g., extended GUI elements 146 of the composite application 140), d) specify input and/or event handling for the composite application 140, and so on.

The GAC module 130 may be configured to implement the composite application 140 by use of the process manager 132, display manager 134, and/or CSM manager 136, disclosed herein. Instantiating the composite application 140 may comprise instantiating the applications 126A-N comprising the composite application 140, by use of the process manager 132. Instantiating the applications 126A-N may comprise a) loading machine-readable instructions into the volatile memory resources 103 of the computing system 101 (e.g., from non-transitory storage resources 104) and/or configuring the processing resources 102 of the computing system 101 to execute the machine-readable instructions.

In the FIG. 2 embodiment, the process manager 132 comprises a process integration facility 232 configured to a) invoke applications 126A-N by use of the application framework 124 and/or operating environment 120 and/or b) maintain application state metadata 131 pertaining to the invoked applications 126A-N. Invoking an application 126A-N may comprise issuing one or more commands, procedure calls, method calls, and/or requests to the application framework 124, AFPM 252, and/or operating environment 120. Maintaining the application state metadata 131 may comprise accessing information pertaining to the applications 126A-N, which may include, but is not limited to: process identifier, application identifier, application name, application path (e.g., path to executable files of the application 126A-N), GUI metadata (e.g., application title, window identifier, window handle, window position, size, orientation, focus), metadata pertaining to input, event, and/or messaging handlers (e.g., a CSM handle, a CSM registration, a CSM end point identifier, and/or the like), and/or queues corresponding to the applications 126A-N, metadata pertaining to application coordination objects, metadata pertaining to data sharing facilities, file handles used by the application(s) 126A-N, and so on. In some embodiments, one or more the applications 126A-N may operate on a remote computing device 111. The process integration facility 232 may be configured to invoke and/or otherwise manage remote applications by use of one or more of an RPC interface, RMI interface, SOAP interface, and/or the like, as disclosed herein.

The display manager 134 may be configured to manage a composite application interface 142 of the composite application 140. The composite application interface 142 may include composite application GUI elements 242, which may include selected native GUI elements 224A-N of the applications 126A-N, extended GUI elements 146 that do not exist in the applications 126A-N, and/or the like. In some embodiments, the composite application 140 comprises a CSM handler (extended CSM handler 246) configured to manage CSM pertaining to GUI elements 242 and, in particular, to CSM corresponding to extended GUI elements 146.

The display manager 134 may generate the composite application interface 142 by use of, inter alia, the composite application metadata 139. The composite application metadata 139 may identify the native GUI elements 224A-N to select for inclusion in the composite application interface 142, specify processing operations to perform on the selected native GUI elements 244, specify native GUI elements to exclude from the composite application interface 242, define additional, custom GUI elements 146 for inclusion in the composite application interface 142, specify the arrangement and/or layout of the composite GUI elements 242 (e.g., relative position, overlay, transparency, within the composite application interface 142), and so on.

As disclosed above, the applications 126A-N comprising the composite application 140 may include respective native GUI elements 224A-N. The display manager 134 of the GAC module 130 may adapt and/or extend the native GUI elements 224A-N to form the composite application interface 142. The display manager 134 may be configured to incorporate native GUI elements 224A-N of one or more of the applications 126A-N into the composite application interface 142, such as GUI areas 127A-N and/or AGUI elements 128A-N, as disclosed above. The display manager 134 may be further configured to adapt the selected native GUI elements 244 for use in the composite application interface 142. Adapting a native GUI element 224A-N for inclusion as a selected native GUI element 244 may comprise one or more of: moving, resizing, scaling, cropping, morphing, embedding, processing (e.g., applying image processing operations, such as transparency and/or opacity processing), and/or the like. The display manager 134 may be further configured to manage extended GUI elements 146 that do not exist in the applications 126A-N. In some embodiments, the display manager 134 is configured to arrange and/or layout GUI elements within the composite application interface 142 in accordance with the composite application metadata 139.

The display manager 134 may comprise a display integration facility 234 configured to access and/or adapt native GUI elements 224A-N of the applications 124A-N. The display manager 134 may use the display integration facility 234 to adapt particular native GUI elements 224A-N for inclusion in the composite application interface 142. The display integration facility 234 may be configured to access and/or modify native GUI elements 224A-N within a virtual display 255 of the AFDM 254, by identifying native GUI requests pertaining to the native GUI elements 224A-N, and/or the like.

In one embodiment, the display manager 134 is configured to modify native GUI elements 224A-N within the virtual display 255 of the AFDM 254 (before the unmodified native GUI elements 224A-N are shown on the display device(s) 106 of the computing system 101). The display integration facility 234 may identify native GUI elements 224A-N of the applications 126A-N by use of the application state metadata 131 (e.g., using the process identifiers, window identifiers, window handles, etc. associated with the applications 126A-N and/or native GUI elements 224A-N). The display integration facility 234 may implement modification operations on the identified native GUI elements 224A-N to adapt the native GUI elements 224A-N for use within the composite application interface 142 (e.g., in accordance with the composite application metadata 139). The native GUI elements 224A-N may be adapted by manipulating the native GUI elements 224A-N within the virtual display 255 (e.g., by issuing requests and/or API calls to the AFDM 254).

Alternatively, or in addition, the display integration facility 234 may be configured to identify and/or capture native GUI requests of the applications 126A-N (as opposed to identifying and/or modifying the native GUI elements 224A-N within the virtual display 255). As disclosed above, a native GUI request refers to a request, interface call, method invocation, and/or other interaction pertaining to the native GUI element(s) 224A-N of an application 126A-N. The display integration facility 234 may be configured to identify and/or capture native GUI requests issued to the application framework 124, AFDM 254, and/or operating environment 120. The native GUI requests may be identified and/or captured before the corresponding native GUI element(s) 224A-N are presented on the display device(s) 106 of the computing system 101. In one embodiment, the display integration facility 234 identifies and/or captures the native GUI requests by detecting requests to create the native GUI elements 224A-N within the virtual display 255 of the AFDM 254. Accordingly, in some embodiments, the display integration facility 234 is configured to monitor native GUI requests of the applications 126A-N. The display integration facility 234 may comprise and/or be communicatively coupled to a parent window of one or more of the applications 126A-N, may be registered as a listener and/or handler of native GUI requests (e.g., a listener and/or CSM handler between the applications 126A-N and the application framework 124), and/or the like.

In response to identifying native GUI elements 224A-N of the applications 126A-N and/or capturing native GUI requests to generate the native GUI elements 224A-N, the display manager 134 may a) determine whether the identified native GUI elements 224A-N are to be included in the composite application interface 142 (based on the composite application metadata 139), and if so b) adapt the native GUI element 224A-N for inclusion in the composite application interface 142 in accordance with the composite application metadata 139 (as a selected native GUI element 244, as depicted in FIG. 2). Adapting native GUI elements 224A-N may comprise issuing GUI requests to the application framework 124 and/or AFDM 254 to modify the native GUI elements 224A-N, as disclosed herein. Adapting native GUI elements 224A-N may further include performing image processing operations on the native GUI elements 224A-N by use of an image processing facility 235, which may include, but is not limited to an image processing application, library, interface, API, service, and/or the like. Adapting the native GUI elements 224A-N for inclusion in the composite application interface 142 may, therefore, comprise one or more of a) intercepting and/or modifying native GUI requests issued by applications 126A-N, b) modifying native GUI elements 224A-N within a virtual display 255 (and/or other representation of the native GUI elements 224), c) issuing GUI requests to modify particular native GUI elements 224A-N, d) performing image processing operations on the native GUI elements 224A-N, and/or the like. Native GUI elements 224A-N that are not included in the composite application interface 142 may be removed by one or more of a) intercepting native GUI requests to create and/or initialize the native GUI elements 224A-N, b) removing the native GUI elements 224A-N from the virtual display 255, c) issuing GUI requests to remove the particular native GUI elements 224A-N, d) performing image processing operations to crop, scale, and/or otherwise remove the particular native GUI elements 224A-N (by use of the image processing facility 235), and/or the like.

The display manager 134 may be further configured to manage extended GUI elements 146 for inclusion in the composite application interface 142. The display manager 134 may generate extended GUI elements 146 by use of the application framework 124 and/or AFDM 254 (e.g., by issuing GUI requests to create the extended GUI elements 146). The extended GUI elements 146 may be created in accordance with the composite application metadata 139 disclosed herein. The display manager 134 may be further configured to adapt the layout and/or appearance of the GUI elements 242 within the composite application interface 142, as disclosed herein. The extended GUI elements 146 may correspond to an extended CSM handler 246 of the composite application 140, as disclosed in further detail herein.

The composite application interface 142 generated by the display manager 134 and/or display integration facility 234 may be presented on the display device(s) 106 of the computing system 101 by the application framework 124 and/or operating environment 120. A user may interact with the composite application GUI elements 242 by use of, inter alia, the input devices 107 of the computing system 101.

The CSM manager 136 is configured to manage CSM pertaining to the composite application 140 (e.g., composite application GUI elements 242), including native GUI elements 224A-N, extended GUI elements 146, and the like. In some embodiments, the CSM manager 136 comprises a CSM handler (extended CSM handler 246) of the composite application 140. The CSM manager 136 may be configured to identify CSM pertaining to the composite application 142 and to direct the CSM to a corresponding application 126A-N and/or native CSM handler 226A-N. The CSM manager 136 may be configured to identify and/or capture CSM by one or more of a) acting as an intermediary for inputs and/or events pertaining to the composite application 140 (an intermediary for particular CSM within the application framework 124), b) filtering inputs and/or events within the application framework 124 (e.g., within the AFCM 256 and/or messaging facility 257), and/or the like.

In some embodiments, the CSM manager 136 comprises a CSM integration facility 236 configured to act as an intermediary for inputs and/or events pertaining to the composite application 140. The CSM integration facility 236 may be configured to receive and/or intercept inputs and/or events directed to the composite application GUI elements 242, including selected native GUI elements 244 and/or extended GUI elements 146. The CSM integration facility 236 may receive and/or intercept inputs and/or events by one or more of: a) acting as a CSM handler for one or more of the composite application 140, particular GUI elements 242 of the composite application 140 (e.g., selected native GUI elements 244 and/or extended GUI elements 146), b) acting as a CSM handler for a top-level interface element of the composite application 140 (e.g., a parent window), c) acting as a CSM handler for child windows and/or native GUI elements 244 of the applications 126A-N, d) acting as a CSM handler for all inputs and/or events within the application framework 124, e) identifying inputs and/or events pertaining to the composite application within AFCM 256 (e.g., filtering messages in the messaging facility 257), f) intercepting inputs and/or events 202 from a user, and/or the like. Acting as a CSM handler for particular CSM messages may comprise registering as a CSM handler with the application framework 124, AFCM 256, operating environment 120, and/or the like.

The CSM manager 136 may be further configured to direct CSM to particular event handlers. In some embodiments, the CSM manager 136 identifies a CSM pertaining to a particular application 126A-N and, in response, directs the CSM to the corresponding CSM handler 226A-N of the particular application 126A-N. The CSM manager 136 may correlate inputs and/or events corresponding to particular CSM with particular applications 126A-N by use of the application state metadata 131. In one embodiment, the CSM manager 136 determines the application 126A-N associated with a particular CSM based on a process identifier, process handle, application identifier, window identifier, GUI element identifier, and/or the like. The CSM manager 136 may be configured to direct CSM to particular applications 126A-N by use of the application framework 124 by one or more of: reissuing the CSM within the application framework 124, generating a new CSM directed to the application 126A-N by use of the application framework 124, and/or the like.

In some embodiments, the CSM manager 136 is configured to modify CSM for use by a native CSM handler 226A-N of a particular application 126A-N and/or the extended CSM handler 246. In one embodiment, the CSM manager 136 identifies a CSM corresponding to selection of a “File Save” native GUI element 224A of application 126A. In response, the CSM manager 136 may direct the CSM to the native CSM handler 226A of the application 126A. The CSM manager 136 may be further configured to determine a file name associated with the “File Save” CSM, and issue another CSM that includes the file name to one or more of the other applications 126B-N of the composite application 140.

The CSM manager 136 may be further configured to split or multiplex CSM within the composite application 140. In one embodiment, the CSM manager 136 identifies a CSM corresponding to an extended GUI element 146 and, in response, issues two or more CSM to respective applications 126A-N. The CSM may be adapted for use by native CSM handlers 226A-N of the respective applications 126A-N. The CSM manager 136 may, for example, identify a CSM corresponding to a “zoom-in” extended GUI element 146. In response, the CSM manager 136 may issue two or more “zoom-in” CSM to respective applications 126A-N. The two or more CSM may be adapted to emulate CSM corresponding to “zoom-in” native GUI elements 224A-N of the respective applications 126A-N.

The CSM manager 136 may be further configured to filter CSM pertaining to the composite application 140. In one embodiment, the CSM manager 136 filters CSM pertaining to native GUI elements 224A-N that have been removed from the composite application interface 142 (e.g., removed GUI elements 129A). As disclosed above, removing a native GUI element 224A-N may comprise overlaying and/or hiding the native GUI element 224A-N by use of the display manager 134. Accordingly, the native GUI elements 224A-N may be instantiated within the application framework 124 and/or operating environment 120, but may not be visible and/or accessible to a user of the composite application. Such GUI elements may receive CSM due to system events, general inputs, and/or the like. The CSM manager 136 may identify CSM directed to removed native GUI elements 224A-N and filter the CSM such that the corresponding CSM is not received by the native CSM handler(s) 226A-N of the respective applications 126A-N. Filtering a CSM may comprise removing the CSM from the messaging facility 257, ignoring the CSM, consuming the CSM (e.g., reporting to the application framework 124 that the CSM has been handled), and/or the like.

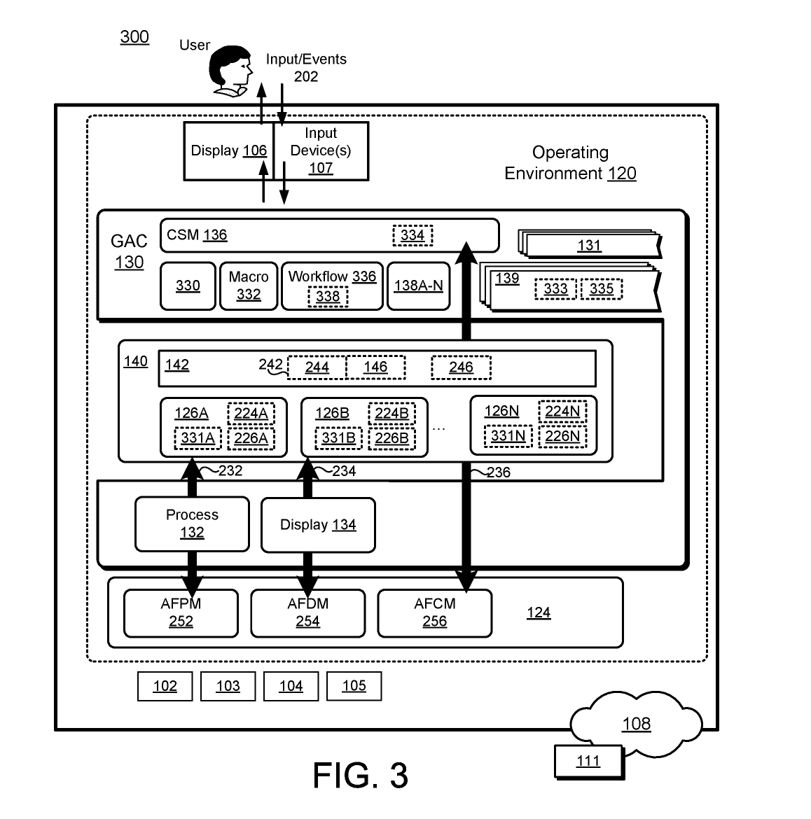

FIG. 3 is a schematic block diagram of another embodiment of a system 300 for managing composite applications. The system 300 includes a GAC module 130 configured for operation on the computing system 101. As disclosed herein, the GAC module 130 may be configured to manage the composite application 140 by: a) instantiating the applications 126A-N by use of the process manager 132, b) generating a composite application interface 142 comprising native GUI elements 224A-N of the applications 126A-N and/or extended GUI elements 146, and/or c) managing CSM pertaining to the composite application by use of the CSM manager 136. The GAC module 130 may be further configured to maintain application state metadata 131 pertaining to the composite application 140 and/or corresponding applications 126A-N. The application state metadata 131 may include information pertaining to the processes associated with the applications 126A-N (e.g., process identifier, application name, application handle, window handle, and/or the like). The application state metadata 131 may further include application-specific information, such as an identifier of a document and/or file open in an application, the current state of a presentation application (e.g., slide currently displayed), and/or the like. In some embodiments, the application state metadata 131 further includes information pertaining to application coordination facilities of the application framework 124, such as the contents of an application clipboard and/or the like.

In some embodiments, the GAC module 130 further includes an application integration manager 330. As disclosed above, the GAC module 130 may configure and/or manage applications 126A-N by use of user inputs and/or events (e.g., by issuing CSM to the applications 126A-N by use of, inter alia, the CSM manager 136). Certain applications 126A-N may provide additional, application-specific interfaces for more finely grained application control, such as application-specific APIs, toolkits, scripting systems (e.g., Visual Basic Script, Maya Embedded Language (MEL), etc.), and/or the like. The application integration manager 330 may be configured to access application-specific interfaces to: a) manage particular applications 126A-N (e.g., in place of and/or in addition to issuing CSM to the particular applications 126A-N), and/or b) create and/or manage application coordination objects (ACO) 331A-N within the particular applications 126A-N. As used herein, an ACO 331A-N refers to an application-specific object (and/or other interface mechanism) configured to leverage application-specific functionality of an application 126A-N. ACOs 331A-N may be configured to facilitate incorporation of the application 126A-N into a composite application 140, perform automated macro, scripting, and/or workflow operations pertaining to the application 126A-N, access information pertaining to an application 126A-N (e.g., access a document object model (DOM), access presentation shapes, etc.), and/or the like. The application integration manager 330 may create and/or manage ACOs 331A-N by use of application-specific interfaces, APIs, toolkits, scripting systems (e.g., Visual Basic Script, Maya Embedded Language (MEL) scripts, etc.), and/or the like. In one embodiment, a presentation application 126A-N exposes interfaces for manipulating presentation objects and/or presentation state. An ACO 331A-N may be used to manage the presentation application (e.g., start/end a presentation, determine and/or change the active slide of the presentation, and so on), manage presentation objects (e.g., determine the size and/or position of presentation objects, manipulate presentation objects, and so on), and/or the like.

As disclosed above, an ACO 331A-N may be implemented as an add-in and/or plug-in to an application 126A-N. Accordingly, an ACO 331A-N may be embodied as machine-readable code stored on a non-transitory storage medium, such as the storage resources 104 of the computing system 101. The machine-readable code comprising an ACO 331A-N may be configured for execution within and/or interpretation by a particular application 126A-N. Although FIG. 3 depicts an ACO 331A-N within each application 126A-N, the disclosure is not limited in this regard, and could be used in embodiments in which one or more applications 126A-N do not include an ACO 331A-N and/or one or more applications 126A-N comprise a plurality of different ACOs 331A-N.

In the FIG. 3 embodiment, the GAC module 130 further includes a macro engine 332. The macro engine 332 may be configured to, inter alia, manage applications 126A-N comprising the composite application 140 (by use of the process manager 132, display manager 134, and/or CSM manager 136 of the GAC module 130). In some embodiments, the macro engine 332 is configured to implement operations to put the composite application 140, and/or the applications 126A-N thereof, into a particular state and/or configuration. The macro engine 332 may implement a sequence of operations needed to initialize the composite application 140 and/or applications 126A-N, which may include, but are not limited to: a) invoking one or more applications 126A-N by use of the process manager 132, b) accessing identifying metadata pertaining to the invoked applications 126A-N (e.g., process identifier, window name, handle, and/or the like), c) manipulating the applications 126A-N to place the applications 126A-N into a desired state (by use of the CSM manager 136), d) terminating application(s) 126A-N, e) loading and/or accessing ACOs 331A-N into the applications 126A-N, and so on. Manipulating an application 126A-N may comprise invoking an application 126A-N (by use of the process manager 132), issuing CSM to the application 126A-N (e.g., issuing inputs and/or events to the application 126A-N by use of the CSM manager 136), configuring add-ins and/or plug-ins of the applications 126A-N (e.g., ACOs 331A-N), manipulating application data and/or objects by use of ACOs 331A-N (and/or by use of the application integration manager 330), and so on. Manipulating an application 126A-N may further include, but is not limited to: loading data into an application 126A-N (e.g., loading files, accessing network data, accessing shared data, such as a clipboard, and/or the like), exporting and/or exposing data to other applications 126A-N (e.g., placing data on a clipboard, storing data to a file, and/or the like), configuring native GUI elements 224A-N of the application 126A-N (e.g., configuring native GUI elements 224A-N to display a particular set of data in a particular view), and so on. The operations performed by the macro engine 332 for a particular composite application 140 may be specified in, inter alia, macro scripts 333 maintained within the composite application metadata 139 of the composite application 140 (and/or in another storage location).

In some embodiments, the macro engine 332 comprises a CSM recorder 334 configured to, inter alia, selectively capture and/or record CSM pertaining to the composite application 140 (including the applications 126A-N thereof). The CSM recorder 334 may capture user inputs and/or events 202 used to place the composite application 140 and/or constituent application(s) 126A-N into a particular state. The user inputs and/or events 202 captured by the CSM recorder 334 may be stored as a sequence of independent macro scripts 333. The macro engine 332 may replay the macro scripts 333 to automatically place the composite application 140 into the same, or similar, state at a later time. The macro scripts 333 may define a particular state and/or behavior of an application 126A-N, such that the macro scripts 333 of a particular application 126A are independent of macro scripts 333 pertaining to other applications 126B-N.

As disclosed above, macro scripts 333 may be defined by recording user inputs and/or events 202 (e.g., mouse events, keyboard events, and/or the like) by use of the CSM recorder 334. The CSM recorder 334 may associate captured user inputs and/or events 202 with a corresponding application 126A-N (e.g., a respective window or other interface element). The CSM recorder 334 may be further configured to normalize the macro scripts 333. As used herein, “normalizing” a macro entry 333 refers to associating the macro entry 333 with a generic identifier that is independent of a particular instance of the application 126A-N (and/or composite application 140). In some embodiments, the CSM recorder 334 assigns normalized application identifiers to macro elements 333 based on one or more of: a) the order in which the corresponding application instance(s) 126A-N were instantiated within the composite application 140, b) a unique name associated with an application 126A-N (e.g., executable name, signature, and/or the like), c) parent-child relationships between applications 126A-N within the composite application 140, and so on.

The CSM recorder 334 may be further configured to capture and/or record contextual information pertaining to user inputs and/or events 202 (e.g., as part of a set of macro scripts 333). In response to a mouse click user event 202, for example, the CSM recorder 334 may record the size of the corresponding window, window coordinates, and/or coordinates of the mouse pointer relative to the composite application interface 142 (e.g., within a top-level window). The contextual information may enable the corresponding macro entry 333 to be played back independent of the size and/or position of the GUI elements 242 (e.g., windows) within the composite application interface 142. The contextual information may also enable the macro engine 332 to be used on different computing systems 101 comprising different display types and/or input devices (e.g., different resolution monitors, multiple monitors, and/or the like).

In some embodiments, the contextual information of a macro entry 333 further comprises timing information, such as the time between particular user inputs and/or events 202. The timing information may be used to define a timeline of a macro script 333, such that the operations of the macro script 333 can be played back by the macro engine 332 in a way that mimics the user interactions captured by the CSM recorder 334.

The macro engine 332 may be configured to record and/or playback macro scripts 333 corresponding to any suitable type of user input and/or event 202 corresponding to any suitable operation, including, but not limited to: launching one or more applications 126A-N, terminating one or more applications 126A-N, manipulating GUI elements 242 of the composite application 140 (e.g., moving, resizing, and/or repositioning GUI elements 242), modifying application focus, and/or the like. The macro engine 332 may be further configured to record and/or play back custom scripts 333 comprising operations that do not correspond to a specific type of user input and/or event 202, such as an operation to activate an ACO 331A-N of an application 126A-N, to invoke a remote application, to perform a remote procedure call, to invoke a remote object (through SOAP and/or RMI), and/or the like.

The macro scripts 333 disclosed herein provide access to scripting and/or programmatic access to functionality implemented by the GAC module 130. The macro scripts 333 may comprise a sequence of operations performed on the composite application and/or applications 126A-N (e.g., a collection of serial operations). In some embodiments, the GAC 130 further includes a workflow manager 336 that coordinates execution of macro scripts 333.

In some embodiments, the workflow manager 336 is configured to associate macro scripts 333 and/or collections of macro scripts 333 with actions 335. As used herein, an “action” refers to a condition upon which execution of one or more macro scripts 333 is predicated. An action 335 may include, but is not limited to: a trigger condition, a schedule, a CSM, a user input and/or event 202 (e.g., manipulation of an extended GUI element 146), and/or the like. The workflow manager 336 may execute the macro scripts 333 associated with an action 335 by use of the macro engine 332, as disclosed herein. In some embodiments, the workflow manager 336 is configured to a) identify trigger conditions pertaining to an action 335 (by use of the CSM manager 136) and b) execute the macro script(s) 333 associated with the action 335 in response to identifying the trigger condition (by use of the macro engine 332). Identifying a trigger condition may comprise a) monitoring CSM pertaining to the composite application 140 (by use of the CSM manager 136), b) monitoring application state metadata 131, and/or the like. In one embodiment, an action 335 is configured for execution in response to a particular user input and/or event 202 (e.g., interaction with GUI elements 242 of the composite application interface 142). In another embodiment, an action 335 is configured for execution in response to loading a file into one of the applications 126A-N of the composite application 140. In another embodiment, an action 335 may be configured for execution in response to a CSM pertaining to one of the applications 126A-N. For example, one or more of the applications 126A-N may be configured to display and/or analyze time-dependent data, such as a video stream, audio stream, timeline, a series of measurements, and/or the like. The workflow manager 336 may a) detect a time step change in a first one of the applications 126A, and in response b) execute macro script(s) 333 of an action 335 to manipulate the view of one or more other applications 126B-N in accordance with the detected time step change.

The workflow manager 336 may be further configured to coordinate data flow between applications 126A-N, regardless of whether the applications 126A-N are configured to application-to-application coordination. In one embodiment, the workflow manager 336 is configured to facilitate application coordination through the use of data sharing facilities, such as a clipboard (and/or other buffer) managed by the application framework 124 and/or operating environment 120, shared files, in-memory files, shared pipes, application-specific data sharing facilities, custom data sharing facilities (e.g., implemented by use of ACOs 331A-N), and/or the like. The workflow manager 336 may facilitate data coordination within the composite application 140 by: a) executing macro script(s) 333 that configure applications 126A-N to provide data to one or more data sharing facilities, and b) executing macro script(s) 333 that configure applications 126A-N to access data available through one or more data sharing facilities. The workflow manager 336 may be further configured to facilitate data sharing between applications 126A-N having incompatible data formats. In one embodiment, the workflow manager 336 is configured to execute a macro script 333 to configure applications 126A-N to export and/or import data in a format used by one or more other applications 126A-N. Alternatively, or in addition, the workflow manager 336 may comprise and/or be communicatively coupled to a conversion engine 338 and/or ACO 331A-N configured to convert data from a format used by a first application 126A into a format usable by a second application 126B.

In one embodiment, the GAC module 130 includes one or more utility applications 138A-N, including a debugger application 138A, authoring application 138B, shell application 138N, and so on. The debugger application 138A may be implemented as a stand-alone application 126A-N, as a composite application 140, as an ACO 331A-N within one or more other applications 126A-N, and/or the like. The debugger application 138A may provide a step-by-step debugger for composite applications 140 and corresponding macro scripts 333 and/or actions 335. In some embodiments, the debugger application 138A comprises GUI elements 242 (e.g., a window, display area, etc.), to display, inter alia, portions of the application state metadata 131 pertaining to the composite application 140, display the macro elements 333 and/or actions 335 to be executed by the macro engine 332, and so on. In one embodiment, the debugger application 138A comprises a macro step utility to implement selected macros entries 333 and/or actions 335. In some embodiments, the debugger application 138A configures the macro engine 332 and/or workflow manager 336 to execute macro scripts 333 and/or actions 335 corresponding to the composite application 140, and displays the results of the execution of the macro scripts 333 and/or actions 335 to a user on the display device(s) 106 of the computing system 101. In another embodiment, the debugger application 138A configures the macro engine 332 and/or workflow manager 336 to execute selected macro scripts 333 and/or actions 335 (e.g., in a step-wise manner) to allow a user to determine the effect of execution of particular macro scripts 333 and/or actions 335. The debugger application 138A may be further configured to pause the macro engine 332 and/or workflow manager 336 in response to breakpoints defined within the macro scripts 333 and/or actions 335 (e.g., breakpoints within a macro script 333 and/or action 335). The debugger application 138A may be further configured to “roll back” certain operations of a macro script 333 and/or action 335 by, inter alia, implementing operations to undo the effect of such operations (e.g., restore the application state at a previous time).

The authoring application 138B may be configured to facilitate development of composite applications 140. The authoring application 138B may be implemented as a stand-alone application 126, a composite application 140, an ACO 331A-N within an application 126A-N, and/or the like. The authoring application 138B may comprise GUI elements 242 to enable a user to develop a composite application interface 142. The authoring application 138B may include a native GUI selection module to: a) identify native GUI elements 224A-N for inclusion in the composite application interface 142, b) identify native GUI elements 224A-N for exclusion from the composite application interface 142, c) specify processing on native GUI elements 224A-N (e.g., resizing, image processing, and/or the like), d) specify a layout of native GUI elements 224A-N within the composite application interface 142 (e.g., position, size, arrangement, etc.), and so on. The authoring application 138B may further include mechanisms for authoring extended GUI components 146 and/or specifying extended GUI components 146 for inclusion into the composite application interface 142. The authoring application 138B may be further configured to specify CSM handling characteristics of the composite application 140, such as CSM to be handled by particular native CSM handlers 226A-N, modifications to CSM for use by particular native CSM handlers 226A-N (e.g., CSM translation, reformatting, splitting, and/or the like), CSM to be handled by an extended CSM handler 246 of the composite application 140, and so on.

In some embodiments, the authoring application 138B is further configured to facilitate development of macro scripts 333 and/or actions 335 pertaining to the composite application. The authoring application 138B may be configured to: a) record CSM pertaining to the applications 126A-N (e.g., record user-specified inputs and/or events 202 to place the applications 126A-N of a composite application 140 into a desired state, by use of the CSM recorder 334), b) generate macro scripts 333 from the recorded CSM for execution by the macro engine 332, c) specify macro scripts 333 independent of user inputs and/or events 202, d) define actions 335 pertaining to execution of the macro script 333 by the workflow manager 336, and so on.

The shell application 138N may comprise a baseline, generic application, for use as a starting point for authoring a composite application 140. The shell application 138N may include an empty top-level window interface, one or more GUI elements 242 (e.g., a top-level display pane), one or more extended GUI components 146, an extended CSM handler 246, and/or the like. In some embodiments, a user may create a composite application 140 by populating the shell application 138N with applications 126A-N, native GUI elements 224A-N, additional extended GUI elements 146 and/or CSM handler 246, and/or the like, by use of the authoring application 138B and/or debugging application 138A.

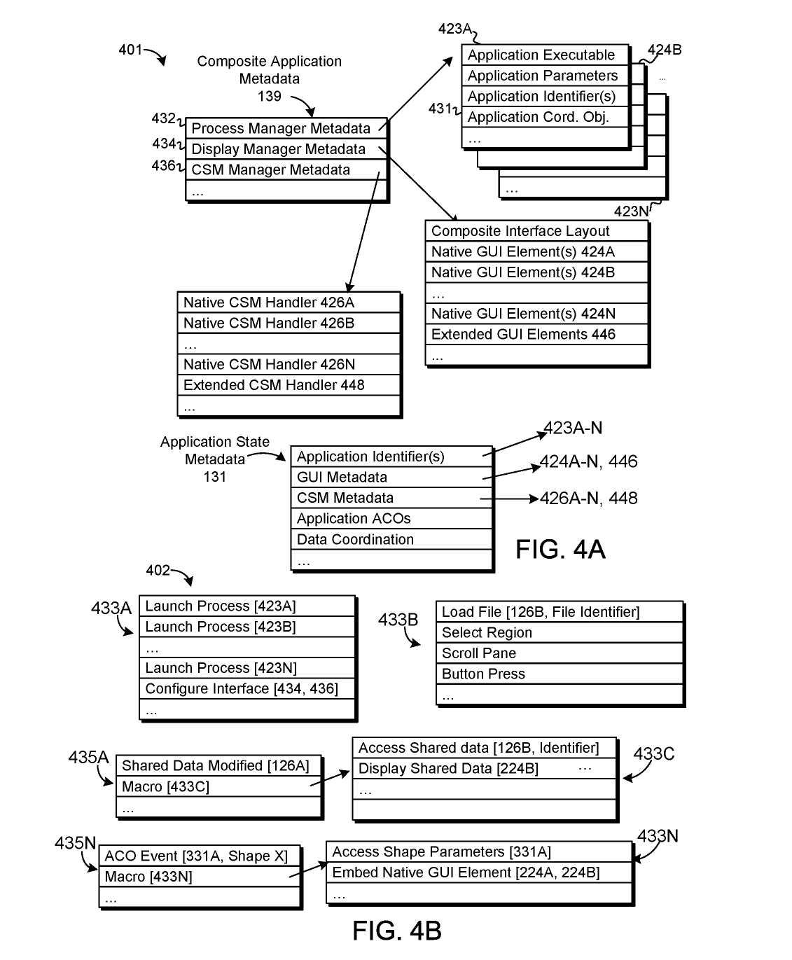

As disclosed above, the composite application 140 may be implemented and/or defined by use of composite application metadata 139 and/or application state metadata 131. FIG. 4A depicts embodiments 401 of composite application metadata 139 and/or application state metadata 131. The composite application metadata 139 of the FIG. 4A embodiment may be persisted on non-transitory storage resources of a computing system 101 (e.g., storage resources 104). The composite application metadata 139 may be embodied as a file, a structured file (e.g., eXtensible Markup Language, XML file), database entries, and/or the like.

The composite application metadata 139 may be used to, inter alia, define a composite application 140. In the FIG. 4A embodiment, the composite application metadata 139 includes process manager metadata 432. The process manager metadata 432 may include application entries 423A-N pertaining to the applications 126A-N comprising the composite application 140. The application entries 423A-N may be accessed by the process manager 132 (and/or macro engine 332) to instantiate applications 126A-N by use of the application framework 124, AFPM 252, and/or operating environment 120, as disclosed herein. The entries 423A-N may include information pertaining to instantiation of an application 126A-N, which may include, but is not limited to: an application executable (e.g., application executable file name, path, etc.), application execution parameters, application identifier(s), and so on. The application identifier(s) may be configured to facilitate identification of the instantiated application(s) 126A-N within the application framework 124 and/or AFPM 252 (e.g., facilitate identification of processes corresponding to the applications 126A-N, an application handle, application window handle, and/or the like). The application entries 423A-N may further include metadata 431 pertaining to ACOs 331A-N to load within the applications 126A-N. The ACO metadata 431 may be used by the application integration manager to load ACOs 331A-N into particular applications 126A-N (e.g., as add-ins, plug-ins, and/or the like), access application-specific interfaces, and so on.

The composite application metadata 139 may further comprise display manager metadata 434. The display manager metadata 434 may specify the layout and/or configuration of the composite application interface 142, which may include, but is not limited to: a size and/or position of top-level GUI elements 242 of the composite application 140 (e.g., a top-level and/or parent window), size, position, arrangement and/or configuration of GUI elements 242 within the composite application interface 142, and so on. The display manager metadata 434 may further include entries 424A-N pertaining to native GUI elements 244 of the applications 126A-N comprising the composite application 140. The entries 424A-N may: a) identify native GUI element(s) 224A-N to include in the composite application interface 142, b) specify a size, position, layout and/or configuration of the native GUI element(s) 224A-N, c) specify processing to perform on the native GUI element(s) 224A-N (e.g., image processing operations, transparency, opacity, etc.), d) identify native GUI element(s) 224A-N to remove and/or exclude from the composite application interface 142, and so on. The entries 424A-N may include identifying information pertaining to the native GUI elements 224A-N, such as name, position within the respective application 126A-N, application identifier, application handle, window name, window handle, and/or the like, as disclosed herein.

The display manager metadata 434 may further include metadata 446 pertaining to extended GUI elements 146 of the composite application 140. As disclosed herein, an extended GUI element 146 refers to a GUI element of a composite application 140 that does not exist in any of the application(s) 126A-N comprising the composite application 140. Accordingly, an extended GUI element 146 may extend the GUI functionality of composite application 140 to include inputs, interfaces, and/or displays not available in the corresponding applications 126A-N. In some embodiments, the metadata 446 pertaining to extended GUI elements 146 may indicate a name, path, and/or location for executable code to implement the respective extended GUI elements 146. The metadata 446 may further include a size, position, layout, and/or configuration of the extended GUI elements 146 within the composite interface 142.

As disclosed herein, the composite application metadata 139 may include information pertaining to the size, position, layout, and/or configuration of the composite application interface 142, native GUI elements 224A-N, extended GUI elements 146, and the like (e.g., composite application GUI elements 242). Such size, position, layout, and/or configuration information may be specified using any suitable mechanism including, but not limited to: a) absolute size, position, layout, and/or configuration parameters, b) relative size, position, layout, and/or configuration parameters, c) proportional size, position, layout, and/or configuration parameters, and/or the like. In some embodiments, the size, position, layout, and/or configuration of GUI elements 242 are specified for use in a particular display environment (e.g., a display device 106 having a particular resolution and/or boundaries). In such embodiments, the size, position, layout, and/or configuration of GUI elements 242 may be specified by use of absolute size and/or position parameters (e.g., specific x,y coordinates, size in pixels, and so on). Alternatively, the size, position, layout, and/or configuration of GUI elements 242 may be adapted for use on display device(s) 106, having different size and/or resolution characteristics. In such embodiments, the size, position, layout, and/or configuration of GUI elements 242 may be defined using relative parameters (e.g., a particular GUI element may occupy a particular proportion and/or area within the composite application interface 142).

The composite application metadata 139 of the FIG. 4A embodiment may further include CSM manager metadata 436. The CSM manager metadata 436 may include information pertaining to CSM issued to/from the composite application 140. The CSM manager metadata 436 may include, but is not limited to: metadata 426A-N pertaining to native CSM handler(s) 226A-N of the applications 126A-N, metadata 448 pertaining to extended CSM handler 246 of the composite application 140, and so on. The metadata 426A-N may: a) specify the CSM each application 126A-N is to handle (by use of a respective native CSM handler 226A-N), b) specify processing to perform on CSM directed to the respective native CSM handlers 226A-N (e.g., translation, formatting, splitting, and/or the like), and so on. The CSM manager metadata 436 may further include metadata pertaining to the extended CSM handler 246 of the composite application 140, which, as disclosed above, may be configured to: a) handle CSM pertaining to the GUI elements 242 of the composite application 140, including CSM pertaining to extended GUI elements 146, b) direct CSM to respective applications 126A-N (e.g., to native CSM handlers 226A-N of the applications 126A-N), c) adapt, modify and/or split CSM for use by two or more applications 126A-N, and so on, as disclosed herein. Accordingly, the extended CSM handler metadata 448 may identify CSM to direct to particular native CSM handlers 226, specify CSM processing (if any), and so on.

FIG. 4A further illustrates embodiments of application state metadata 131. As disclosed herein, application state metadata 131 refers to metadata pertaining to the current state of an application 126A-N comprising the composite application 140. Application state metadata 131 may correspond to particular instances of the applications 126A-N comprising a composite application 140 on the computing system 101 (and/or remote computing device 111). The application state metadata 131 illustrated in FIG. 4A includes a set of application identifiers, which, as disclosed above, may comprise a process identifier, process handle, application identifier, application handle, window identifier, window handle, and/or the like. In some embodiments, the application state metadata 131 includes normalized application identifiers. As disclosed above, the application identifier assigned to an application instance may change each time the application 126A-N is instantiated on the computing system 101 (and/or remote computing device 111). Moreover, multiple instances of an application 126A-N may run concurrently on the computing system 101. A normalized application identifier refers to an application identifier that identifies a particular instance of an application 126A-N regardless of changes to the application/process identifier assigned to the application 126A-N within the operating environment 120 and/or despite the presence of other, currently running instances of the application 126A-N. A normalized application identifier may correspond to the application identifier returned in response to invoking an application 126A-N by the process manager 132 and may include ordering information and/or other identifying information to distinguish the application 126A-N from other applications/processes on the computing system 101. The application identifier(s) may correspond to respective application metadata entries 423A-N, disclosed above.

The application state metadata 131 may further comprise GUI metadata pertaining to the GUI elements 242 of the composite application 140. The GUI metadata may correspond to a current state of the composite application GUI elements 242, such as size, position, processing, and/or the like. The GUI metadata may correspond to respective native GUI element metadata entries 424A-N and/or extended GUI element entries 446, disclosed above. The GUI metadata may indicate changes to the state of particular GUI elements 242 in response to user inputs and/or events 202 (e.g., user manipulation of the GUI elements 242), in response to system CSM, in response to execution of a macro script 333, and/or the like. In some embodiments, the GUI metadata includes current size, position, layout, configuration, and/or processing information pertaining to particular GUI elements 242 (e.g., particular native GUI element entries 424A-N, extended GUI element entry 446, and/or the like).

The application state metadata 131 may further include metadata pertaining to CSM pertaining to the composite application 140. The CSM metadata may include information pertaining to CSM directed to particular native CSM handlers 226A-N by, inter alia, the extended CSM handler 246 and/or CSM handled by the extended CSM handler 246. The CSM metadata may further include information pertaining to modifications made to CSM, such as CSM reformatting, CSM augmentation, CSM splitting, and/or the like, as disclosed herein. In some embodiments, the CSM metadata comprises a log of CSM pertaining to the composite application 140. The CSM log may be stored and/or replayed (by the macro engine 332) to place the application into a particular application state, as disclosed herein.

The application state metadata 131 may further include information pertaining to ACOs 331A-N within one or more of the applications 126A-N. The ACO metadata may include an ACO identifier (e.g., ACO handle) through which functionality of the ACO 331A-N and/or information pertaining to the ACO 331A-N can be accessed.

In some embodiments, the application state metadata 131 further includes information pertaining to data coordination (e.g., data sharing) between applications 126A-N within the composite application 140. As disclosed herein, the GAC module 130 may be configured to implement data sharing functionality by use of: a clipboard (and/or other buffer) managed by the application framework 124 and/or operating environment 120, shared files, in-memory files, shared pipes, application-specific data sharing facilities, custom data sharing facilities (e.g., implemented by use of ACOs 331A-N), and/or the like. The data coordination metadata may indicate the current state of such data coordination facilities (e.g., contents of the clipboard and/or other buffer), which may be used to trigger action(s) by the workflow manager 336, as disclosed herein.

Although FIG. 4A depicts composite application metadata 139 and/or application state metadata 131 in a table arrangement, the disclosure is not limited in this regard, and could represent composite application metadata 139 using any suitable format in any suitable data structure and/or arrangement.

FIG. 4B depicts further embodiments 402 of composite application metadata, including a macro script 333. As disclosed above, a macro script 333 may specify a sequence of operations pertaining to a composite application 140. Accordingly, the macro scripts 433A-N depicted in FIG. 4B may be used in addition to, or in place of, the composite application metadata 139 of FIG. 4A.

The macro script 433A may comprise a sequence of operations to launch and/or configure a composite application 140. As illustrated in FIG. 4B, the macro script 433A includes a sequence of “launch process” operations, which may cause the macro engine 332 to launch the corresponding applications 126A-N on the computing system 101 (by use of the process manager 132). In the FIG. 4B embodiment the “launch process” entries 433A correspond to respective application metadata entries 423A-N, which may specify launch parameters, such as application executable name, page, and/or arguments for use in launching the applications 126A-N. Alternatively, or in addition, such parameters may be specified within the respective “launch process” entries of the macro script 433A.

The macro script 433A further specifies operations to create a composite application interface 142 for the composite application 140. The macro engine 332 may execute the specified operations by use of the display manager 134, which may include operations to: a) identify native GUI elements 224A-N for inclusion in the composite application interface 142, b) load extended GUI element(s) 146, c) specify a layout and/or configuration for the native GUI elements 224A-N and/or extended GUI element(s) 146, and so on. The operations may further include configuring the extended CSM handler 246 to direct, redirect, and/or modify CSM pertaining to the composite application 140 for use by respective native CSM handlers 226A-N, as disclosed herein. The operations to create the composite application interface 142 may be specified in the display manager metadata 434 and/or CSM manager metadata 436, disclosed above. Accordingly, entries of the macro script 433A may reference the display manager metadata 434 and/or CSM manager metadata 436, disclosed above. Alternatively, the GUI configuration and/or CSM management for the composite application 140 may be specified within the macro script 433A.

The macro script 433B may comprise operations configured to manipulate GUI elements 242 of the composite application 140 in order to, inter alia, place the composite application 140 into a particular state, facilitate a particular workflow, and/or the like. The macro script 433B may be executed by the macro engine 332 in response to completing execution of the macro entries 433A and/or in response to another trigger condition (e.g., an action 335). Alternatively, the operations of the macro script 433B may be included within macro script 433A. The macro entries 433B may correspond to user inputs and/or events 202 recorded by use of the CSM recorder 334, system CSM, custom operations, and/or the like. In the FIG. 4B embodiment, the macro entries 433B include a “load file” operation to cause an application 126B to load a particular file (as specified by a file identifier). The application 126B may be identified using a normalized application identifier, which, as disclosed herein, may facilitate identification of a particular instance of the application 126B and/or one of a plurality of instances of the application 126B operating on the computing system 101. The macro entries 433B may further include a “select region” operation configured to select a particular region within the composite application interface 142. The selection region may be specified by use of normalized parameters, such that the selection region operation can be implemented on different computing systems 101 having different display configurations (e.g., different display resolutions, aspect ratios, and/or the like, as disclosed herein). The macro script 443B may further include a “scroll pane” operation configured to implement a scroll operation within a particular GUI element 242 of the composite application interface 142, and a “button press” operation configured to activate a button GUI element 242 of the composite application interface 142, and so on.

As disclosed herein, the workflow manager 336 may coordinate execution of macro scripts 333 in response to particular conditions and/or triggers (e.g., actions 335). FIG. 4B depicts embodiments of actions 435A-N and corresponding macro scripts 433C-N. The action 435A corresponds to modification of shared data by a particular application 126A-N (e.g., application 126A). The application 126A may be specified by normalized application identifier, as disclosed herein. The action 435A may correspond to one or more of: the application 126A saving data to a shared file, the application 126A modifying shared data in shared memory (e.g., data stored in a clipboard, shared buffer, and/or the like), and/or other shared data modification operation. The action 435B may specify macro entries 433C to execute in response to detecting the specified trigger condition. The workflow manager 336 may detect the trigger condition of the action 435A by use of the CSM manager 136 (e.g., by detecting a CSM pertaining to the shared data modification), by use of the application integration manager 330 and/or ACO 331A within the application 126A, and/or the like. In the FIG. 4B embodiment, the operations of the macro script 433C are configured to cause another application (application 126B) to access and/or display the data modified by application 126A. The macro script 433C may further include operations to manipulate GUI elements 242, such as native GUI elements 224B of the application 126B, to present the modified shared data on the display device(s) 106 of the computing system 101.

FIG. 4B depicts another embodiment of an action 435N. The trigger condition of the action 435N pertains to an ACO 331A operating within an application 126A-N. The action 435N may, therefore, be triggered in response to application-specific information detected by use of an application-specific API, an ACO 331A, and/or the like. In the FIG. 4B embodiment, the action 435N may pertain to display of a particular shape (shape X) in a presentation application 126A. In response to detecting display of the specified shape, the workflow manager 336 may execute macro script 433N, which may configure the display manager 134 to embed a native GUI element 224B of another application 126B into a GUI element 224A of the application 126A. The native GUI element 224B may be embedded within a particular object of the application 126A (shape X). Accordingly, the macro script 433N may specify operations to: determine parameters pertaining to the shape X (e.g., size, position, bounds, etc.), and embed the native GUI element 224B within a native GUI element 224A of application 126B in accordance with the determined parameters.

Although FIG. 4B illustrates embodiments of exemplary macro scripts 433A-N and/or actions 435A-N, the disclosure is not limited in this regard and could be adapted to incorporate macro scripts 333 and/or actions 335 to implement any suitable operations on the computing system 101 (and/or remote computing device 111) in response to any suitable trigger condition and/or workflow.

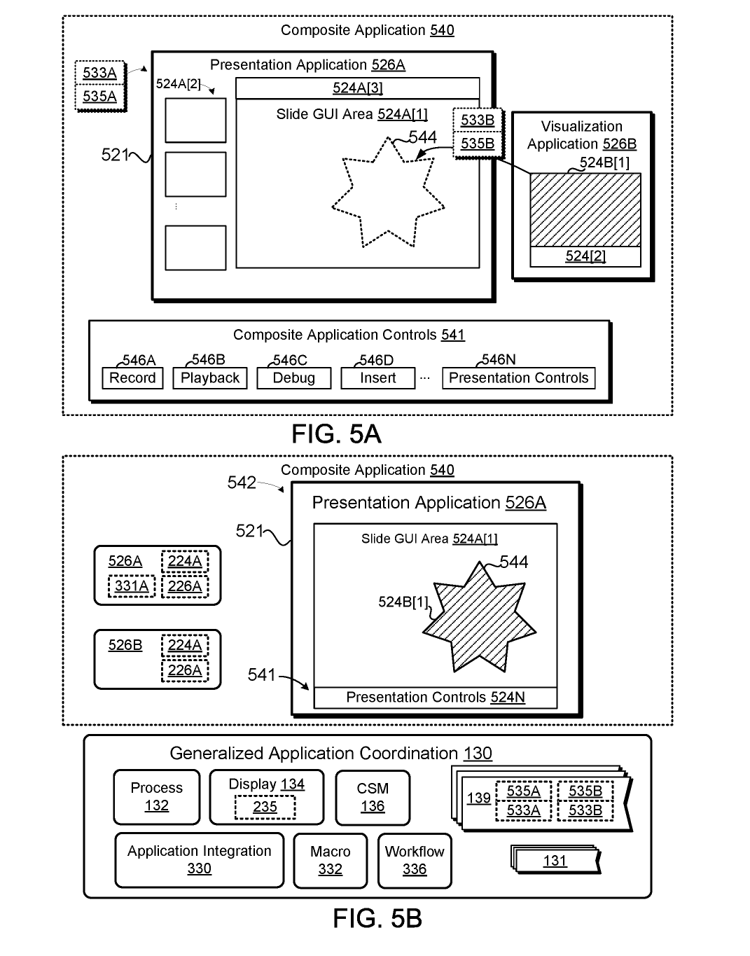

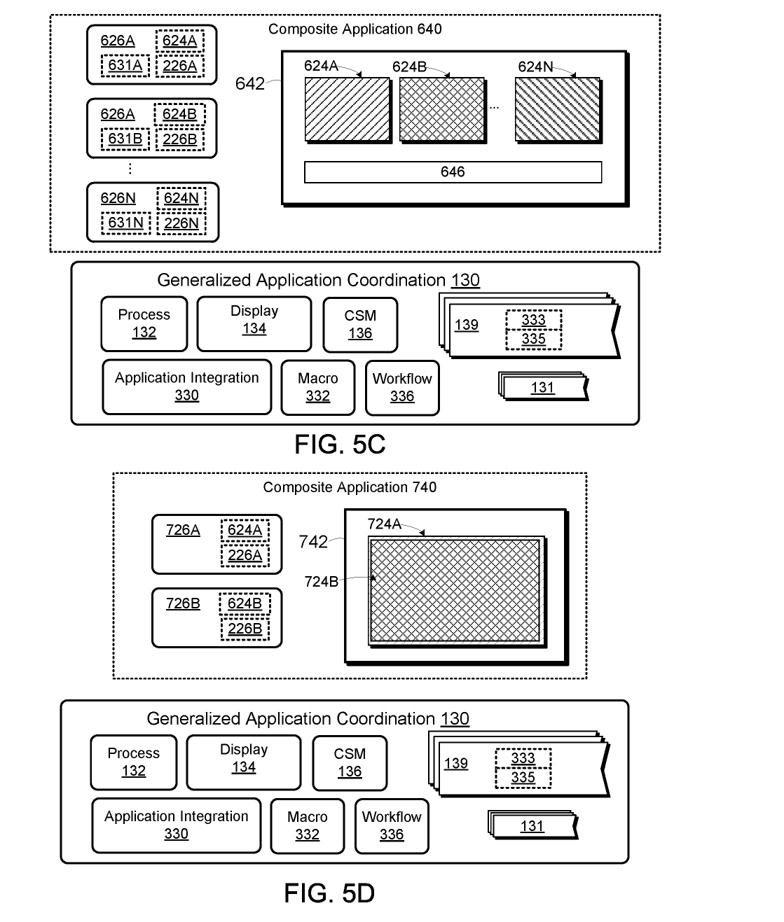

FIG. 5A depicts one embodiment of a composite application 540 configured to, inter alia, coordinate operation of a presentation application 526A. The presentation application 526A may comprise Microsoft POWERPOINT (™), OpenOffice Impress, iWork Keynote, and/or the like. The presentation application 526A may comprise a native GUI interface 521 to author and/or display presentation slides. The native GUI interface 521 may include a slide GUI area 524A[1], slide thumbnails 524A[2], native GUI controls 524A[3], and so on. The composite application 540 may further include a visualization application 526B, which may comprise a data processing and/or visualization application (e.g., MATLAB), a video player application, and/or the like. The visualization application 526B may provide data visualization and/or processing functionality that is not available in the presentation application 526A. As disclosed in further detail herein, the composite application 540 of FIGS. 5A and 5B may comprise a host application (presentation application 526A) into which one or more child applications (e.g., visualization application 526B) may be embedded. The composite application 540 comprising the host presentation application 526A and the child visualization application 526B may be managed by the GAC module 130, as disclosed herein.

The composite application 540 may be implemented by use of one or more macro scripts 333, including a first macro script 533A and a second macro script 533B. The macro scripts 533A and/or 533B may be configured for execution by the macro engine 332. Execution of the macro scripts 533A and/or 533B may be triggered by respective actions 535A and/or 535B. In the FIG. 5A embodiment, the initialization macro script 533A may define operations to launch the host presentation application 526A and one or more child applications 126A-N to embed therein, such as the visualization application 526B. The initialization macro script 533A may be configured to invoke the respective applications 526A and/or 526B at runtime and/or in response to an action 535A. The macro script 533A may further include operations to bring the applications 526A and/or 526B into a particular state. In one embodiment, the macro script 533A is associated with an action 535A, which may specify conditions to trigger initialization of the composite application 540 (e.g., the composite application 540 may be used in a workflow comprising other applications 126A-N and/or composite applications 140). The macro scripts 533A and/or 533B may be authored by use of an authoring application 138B of the GAC module 130, as disclosed above. Alternatively, or in addition, the composite application 540 may incorporate functionality to author and/or modify the composite application 540, as disclosed in further detail herein.

The composite application 540 may comprise composite application controls 541. Although FIG. 5A depicts the composite application controls 541 in a window and/or GUI display area that is separate from the native GUI interface 521 of the presentation application 526A, the disclosure is not limited in this regard, and could be adapted to provide alternative configurations and/or arrangements for the composite application controls 541. In some embodiments, portions of the composite application controls 541 may be embedded within the native GUI interface 521 of the presentation application 526A (as illustrated in FIG. 5B).

The composite application controls 541 may include extended GUI elements 546A-N to author, debug, and/or manage the composite application 540. In the FIG. 5A embodiment, the extended GUI elements 546A-N include, but are not limited to: a record control 546A, a playback control 546B, a debug control 546C, an insert control 546D, and presentation controls 546N. The record control 546A may be configured to record user inputs and/or events pertaining to the composite application 540 (by use of the event recorder 334). The recorded CSM may be stored as macro scripts 333 and/or actions 335 for execution by the macro engine 332 and/or workflow manager 336, as disclosed herein. The playback controls 546B may be configured to execute macro scripts 333 pertaining to the composite application 540 and/or recorded by use of the recorder control 546A using, inter alia, the macro engine 332 of the GAC module 130. The debug controls 546C may leverage the debugging application 138A of the GAC module 130 to selectively playback and/or debug macro scripts 333 and/or actions 335 pertaining to the composite application 540.

The composite application controls 541 may provide for authoring and/or modifying the composite application 540. The insert controls 546D may be used to specify applications 126A-N to embed within the presentation application 526A, such as the visualization application 526B. As illustrated in FIG. 5A, the insert control 546D may provide for embedding the visualization application 526B within a particular object within a presentation slide (e.g., a shape 544). The shape 544 may be identified by use of the application integration manager 330, which may identify selection of the shape 544 within the presentation application 526A by use of, inter alia, application-specific interfaces and/or an ACO 331A within the presentation application 526A. The shape 544 may be identified by use of one or more of: an object identifier, a shape identifier, by use of shape coordinates within the slide GUI area 524A[1], and/or the like. The metadata pertaining to the shape 544, such as shape identifier, size, position, and/or configuration may be recorded in a macro script 533B and/or action 535B, as disclosed in further detail below.

The insert control 546D may be further configured to identify portions of visualization application 526B to embed within the specified shape 544, which may comprise selecting particular native GUI elements 224A-N to include and/or exclude from the composite application 540. In the FIG. 5A embodiment, a user may select a visualization display native GUI element 524B[1] to embed within the shape 544, and may indicate that other native GUI elements 524B[2], such as visualization application controls, application window, menu items, and/or the like are to be excluded. The insert controls 546D may be further configured to provide for specifying processing operations to perform on the selected native GUI element 524B[1], such as scaling, positioning, cropping, morphing, image processing (e.g., filtering, color modifications, etc.), and so on. In the FIG. 5A embodiment, the native GUI element 524B[1] may be fit within the shape 544, which may include scaling, cropping, positioning, and/or morphing the native GUI element 524B[1] to conform to the shape 544. Accordingly, in some embodiments, embedding the visualization display area 524B[1] of application 526B may include use of the application integration manager 330 and/or ACO 331A to a) determine when the particular slide GUI area 524A[1] and/or shape 544 is being displayed and b) determine configuration parameters of the shape 544 (e.g., shape characteristics, size, position, and so on), and c) processing the visualization display area 524B[1] to conform with the determined shape parameters. As disclosed above, the application integration manager 330 and/or ACO 331A may leverage application-specific interfaces to access information pertaining to the presentation application 526A, such as the currently displayed slide, and/or information pertaining to presentation objects, such as the shape 544.

The operations to embed the native GUI element 524B[1] within the shape 544 may be recorded in the macro script 533B. The macro script 533B may be associated with an action 535B, which may trigger execution of the macro script 533B under certain conditions. In the FIG. 5A embodiment, the action 535B may specify that the macro script 533B is to be executed in response to detecting the shape 544 within the slide GUI area 524A[1] and/or display of particular slide(s) that comprise the shape 544 within the slide GUI area 524A[1] of the presentation application 526A. During operation, the workflow manager 336 may detect the trigger condition of the action 535B by use of the application integration manager 330 and, in response, execute the corresponding macro script 533B by use of the macro engine 332. In one embodiment, the application integration manager 330 is configured to poll the presentation application 526A to determine whether the shape 544 and/or slide(s) comprising shape 544 are being displayed. The application integration manager 330 may poll the presentation application 526A by use of an application-specific API and/or ACO 331A. Alternatively, or in addition, the workflow manager 336 may detect display of the shape 544 by use of a callback function (e.g., an ACO 331A within the presentation application 526A may be configured to signal the workflow manager 336 in response to determining that the shape 544 is being displayed). The application integration manager 330 and/or ACO 331A may be further configured to capture shape parameters to facilitate embedding the visualization display area 526B[1] into the shape 544, as disclosed above.

The composite application controls 541 may further include presentation controls 524N to manage playback of the composite application 540. The presentation controls 524N may include controls to: start the presentation, move to a next slide and/or slide animation, stop the presentation, and so on. The presentation controls 524N may include selected native GUI elements 224A-N of the presentation application 526A and/or extended GUI elements 146, as disclosed herein. Accordingly, generating the presentation controls 546N may comprise incorporating native GUI elements 224A-N of the presentation application 526A (e.g., selected native GUI elements 524A[3]) and/or defining extended GUI elements 146 not included in the presentation application 526A. Composite application metadata 139 defining the composite application 540, including the macro scripts 533A and 533B and corresponding actions 535A and/or 535B, may be saved to invoke the composite application 540 when needed.

FIG. 5B depicts further embodiments of a composite application 540 having a composite application interface 542. In the FIG. 5B embodiment, the composite application 540 may be launched by, inter alia, executing one or more macro scripts 533A and/or 533B, disclosed above. Alternatively, or in addition, the composite application 540 may be invoked in response to selection of a “start” control within the presentation controls 524N of FIG. 5A. As disclosed above, the macro script 533A may comprise operations configured to initialize the composite application 540. Executing the macro script 533A may include implementing operations to: a) launch the applications 526A and/or 526B comprising the composite application 540, b) configure the workflow manager 336 to detect trigger conditions of action(s) 535B pertaining to the composite application 540 (e.g., display of the shape 544), and so on. The macro script 533A may further include operations to place the applications 526A and/or 526B into a particular state by, inter alia, issuing CSM to the applications 526A and/or 526B. The operations may comprise loading a particular file into the presentation application 526A, starting a presentation display mode of the presentation application 526A, navigating to a particular slide within the presentation, loading a particular file into the visualization application 526B, configuring the visualization application 526B to operate in a particular mode, and so on. The macro script 553A may be executed by the macro engine 332 in response to an action 535A and/or other user input and/or event 202.

During operation, the workflow manager 336 may monitor the composite application 540 to detect the condition corresponding to action 535B that triggers execution of the macro script 533B (e.g., display of the shape 544). The trigger condition of the action 535B may be detected by use of the CSM manager 136, which may identify CSM related to selection of particular GUI elements 546 within the composite application 540. Alternatively, or in addition, the workflow manager 336 may detect display of the shape 544 by use of the application integration manager 330 and/or ACO 331A, which may be configured to: a) query the presentation application 526A to determine the slide currently being displayed therein, b) receive a callback and/or signal from an ACO 331A within the application 526A, and/or the like. In response to detecting the action 535B, the workflow manager 336 instructs the macro engine 332 to execute the corresponding macro script 533B, which may comprise implementing operations to embed the visualization display area 524B[1] of the visualization application 526B into the slide GUI area 524A[1] of the presentation application 526A, as disclosed herein.

The process manager 132 may be configured to handle CSM pertaining to the composite application 540, including CSM corresponding to native GUI elements 224A-N, such as the slide GUI area 524A[1] and/or visualization display native GUI element 524B[1] and/or CSM corresponding to extended GUI elements, such as the composite application controls 541 (e.g., presentation controls 546N). The CSM manager 136 may be configured to a) direct CSM to native CSM handlers 226A and/or 226B of the applications 526A and/or 526B and/or b) modify CSM for use by the applications 526A and/or 526B. The CSM manager 136 may be configured to identify mouse interactions that occur within the shape 544 and/or particular keyboard inputs, and issue the corresponding CSM to the embedded visualization application 526B. Similarly, mouse interactions that occur outside of the shape 544 may be directed to the presentation application 526A.

The CSM manager 136 may be configured to capture CSM pertaining to the composite application 540 (by use of the CSM integration facility 236), determine the application 526A and/or 526B associated with the captured CSM, and direct the CSM to the identified application 526A and/or 526B, as disclosed herein. In some embodiments, the CSM manager 136 is configured to translate, reformat, and/or split CSM for use by particular native CSM handlers 226A and/or 226B. The CSM manager 136 may be further configured to direct CSM to the applications 526A and/or 526B in response to manipulation of extended GUI components that do not exist in the respective applications 526A and/or 526B. In the FIG. 5B embodiment, the presentation controls 524N may include one or more extended GUI elements 146, such as an extended “visualization” control, configured to manipulate both applications 526A and 526B (e.g., modify the shape 544 and/or contents of the embedded native GUI element 524B[1] of the visualization application 526B. The CSM manager 136 may capture CSM pertaining to the visualization control and, in response, issue CSM to applications 526A and 526B. Issuing the CSM may comprise executing a macro script 333, as disclosed herein. In another embodiment, the presentation controls 546N include controls for performing real-time image processing operations within the visualization display native GUI element 524B[1], such as color, brightness, contrast, saturation, sharpness, transparency, opacity, color replacement, and/or the like. The display manager 134 may implement image processing operations on the embedded visualization display native GUI element 526B[1] (in a virtual display 255, or the like) in response to manipulation of such controls.

In another embodiment, the CSM manager 136 is configured to issue CSM pertaining to the presentation application 526A to the embedded visualization application 526B. During the presentation, a user may manipulate the shape 544 (e.g., resize the shape). In response, the application framework 124 may issue CSM to, inter alia, instruct the application 526A to modify the shape and/or issue CSM indicating that the shape 544 has been modified. The CSM manager 136 may capture such CSM, and reissue the CSM to the visualization application 526B to conform the visualization display area 526B[1] to the modified shape 544.

Although FIGS. 5A-B pertain to a composite application 540 comprising a host presentation application 526A and a child visualization application 526B, the disclosure is not limited in this regard, and could be adapted for composite applications 140 comprising any type of application 126A-N arranged in any suitable host, parent, and/or child relationships. In the FIG. 5C embodiment, the GAC module 130 is configured to manage a composite application 640 used to display and/or manipulate time-variant data. The composite application 640 may comprise a plurality of native GUI elements 624A-N, each configured to display the time-variant data at a different respective time. The GAC module 130 may create the composite application 640 by: a) launching multiple instances of the visualization application 626A-N (by use of the process manager 132), b) configuring each application 626A-N to display time-variant data associated with a particular time (by use of the CSM manager 136, macro engine 332, and/or application integration manager 330), and c) embedding native GUI elements 624A-N of the applications 626A-N into a composite application interface 642 (by use of the display manager 134), as disclosed herein. The GAC module 130 may be further configured to maintain application state metadata 131 pertaining to the various instances of the application 626A-N and/or direct CSM to respective CSM handlers 226A-N of the applications 626A-N (by use of the CSM manager 136), as disclosed herein.

The composite application 640 may further include extended GUI elements 646 to manipulate the applications 626A-N by, inter alia, modifying the time range(s) displayed by the respective applications 626A-N, manipulating data within one or more of the GUI display elements 624A-N, and/or the like (by use of respective ACOs 631A-N within the applications 626A-N).

In another embodiment, the GAC module 130 implements the composite application 640 by use of a single instance of the application 626A. The GAC module 130 may be configured to capture views of the native GUI element(s) 624A of the application 626A displayed at different, respective times, and embed the captured views into the composite application interface 642. In response to selection of one of the captured views in the composite application interface 642, the workflow manager 336 may replace the static, captured view with an embedded instance of the application 626A, which may be manipulated in response to, inter alia, user inputs and/or events 202. The operations to replace the captured view with an embedded native GUI element 624A of the application 626A may implemented by use of a macro script 333, triggered by a particular action 335 (e.g., mouse selection within one of the captured views of the composite application interface 642).

FIG. 5D illustrates another embodiment of a composite application 740. The composite application 740 may be configured to facilitate labeling and/or annotation of large images, such as microscopy imagery. In some embodiments, an imaging system may automatically apply labels and/or annotations to image data, which may be manually verified, corrected, and/or augmented by an expert. The imagery data may be captured at a high resolution (gigapixels in size), which may render operations to manipulate the data cumbersome, even on high-performance computing systems. The composite application 740 may be configured to automate workflow operations to capture, view, annotate, and/or analyze imagery data. The composite application 740 may, therefore, include an out-of-core visualization application 726A and an annotation application 726B (e.g., image editing application). The GAC module 130 may be configured to a) launch the out-of-core viewer 726A and/or annotation application 726B (by use of the process manager 132), and b) generate a composite application interface 742 by, inter alia, overlaying a viewer native GUI element 724A of the out-of-core visualization application within a canvas native GUI element 724B of the annotation application 726B (by use of the display manager 134). The viewer native GUI element 724A may be adapted to the image editor canvas native GUI element 724B (by cropping, scaling, morphing, and/or the like). Accordingly, the contents of the out-of-core viewer 726A may appear to be loaded into the annotation application 726B. A user may manipulate the canvas native GUI element 724B to pan, zoom, and/or navigate within the full-resolution imagery data. In response to such manipulation, the CMS manager 136 may issue corresponding CSM operations to the out-of-core viewer 726A to update the viewer native GUI element 724A (and/or direct the corresponding CSM to the out-of-core image viewer 726A). Image data corresponding to portion(s) of the full image displayed within the overlaid viewer native GUI element 724A may be transferred to the annotation application 726B by use of, inter alia, the clipboard of the operating environment 120 (and/or other data sharing facility). The transfer may be implemented by one or more macro scripts 333 that are triggered by an action 335, such as movement of the user's mouse from the canvas native GUI element 724B (and/or an explicit transfer input). The annotation application 726B may implement annotation operations on the transferred image data within the canvas native GUI element 724B.

In response to a save command, the workflow manager 336 executes a macro script 333 to transfer the image data from the annotation application 726B to the out-of-core viewer application 726A (by use of a clipboard and/or other data sharing facility) and save the transferred image data at a particular resolution and/or viewport within the full image data. The operations of the macro script 333 may be triggered by an action 335, such as selection of a save input of one or more of the application s 724A-B, an extended GUI element 146, and/or the like. The transferred image data may be manipulated to convert and/or transform the transferred image data, modify color channels and/or perform other image processing functions, as disclosed herein. In some embodiments, the GAC module 130 accesses image data to transfer between the applications 724A-B by use of the application integration manager 330 and/or ACO 331A-N, as disclosed herein. In some embodiments, image data is buffered within the GAC module 130 (e.g., stored as application state metadata 131). The buffered image data may be manipulated before and/or during transfer between the applications 724A-B by use of one or more utility applications (not shown), such as image conversion application, compression (and/or decompression) applications, and/or the like.

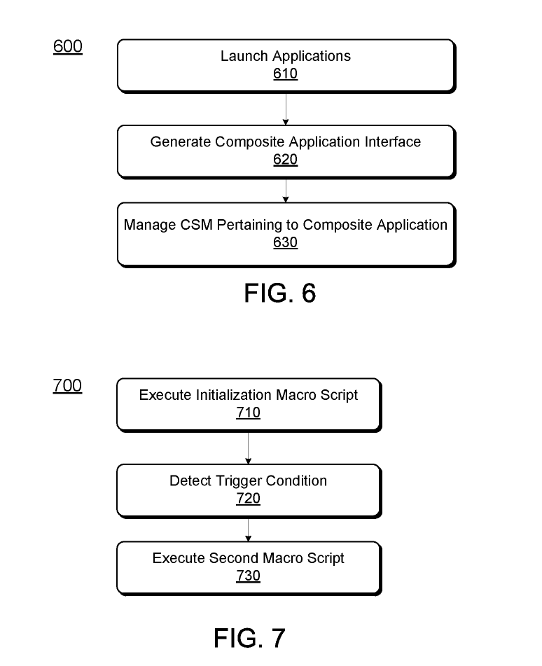

FIG. 6 is a flow diagram of one embodiment of a method 600 for managing a composite application. Step 610 may comprise launching a plurality of applications within an operating environment 120 of a computing system 101. Step 610 may be implemented by use of the process manager 132 disclosed herein. The applications 126A-N may include a host application (e.g., application 526A) and one or more child applications (e.g., 526B). The applications 126A-N may have respective graphical display interfaces comprising respective sets of native GUI elements 224A-N (and corresponding native CSM handlers 226A-N).

Step 620 comprises generating a composite application interface 142 of the composite application 140. Step 620 may include embedding one or more native GUI elements of a first one of the plurality of applications 126A-N into a graphical user interface of a second one of the plurality of applications 126A-N by use of, inter alia, the display manager 134. In one embodiment, step 620 comprises embedding the visualization display area 526B[1] of child application 526B into the slide GUI area 524A[1] of the host application 526A, as disclosed above. Step 620 may further comprise processing the embedded native GUI element 224A-N by one or more of: scaling, positioning, cropping, morphing, performing image processing operations, and/or the like, as disclosed herein. Step 620 may further comprise displaying a composite application interface 142 comprising the native GUI elements 224A-N of two or more different applications 126A-N on a display device 106 of the computing system 101.

Step 620 may further comprise removing one or more of the graphical display elements of the child application. Step 620 may be performed within the virtual display 255 managed by an AFDM 254 of the application framework 124. Alternatively, step 620 may be performed by issuing CSM to the application framework 124 configured to adapt native GUI elements 224A-N of the applications 126A-N to form a composite application interface 142, as disclosed herein.

Step 620 may further include processing native GUI element(s) 224A-N for use in the composite application interface 142 by one or more of: scaling, positioning, cropping, morphing, implementing image processing operations (e.g., filtering, color adjustments, transparency processing, etc.), and/or the like. In some embodiments, step 620 comprises adapting a native GUI element 224A-N to be embedded within a particular object, such as the shape 544 disclosed above in conjunction with FIGS. 5A and 5B. Step 620 may comprise fitting a native GUI element 224A-N (visualization display area 526B[1]) to the shape 544 by one or more of cropping, scaling, positioning, and/or morphing the visualization display area 526B[1].

In some embodiments, step 620 further includes including extended GUI elements 146 within a composite application interface 142. The extended GUI elements 146 may be displayed in a common interface (composite application interface 142) with selected native GUI elements 224A-N of the applications 126A-N. Alternatively, or in addition, step 620 may comprise embedding extended GUI elements 146 within a native GUI interface 521 of a host application 526A with native GUI elements of the host application 526A (e.g., slide GUI area 524A[1]) and/or native GUI elements of a child application 526B (e.g., visualization display area 524B[1]).

Step 630 may comprise managing CSM pertaining to the composite application 140. In some embodiments, step 630 includes redirecting CSM pertaining to the host graphical display interface to the child application 126A-N (e.g., application 526B). Step 630 may comprise capturing CSM pertaining to the composite application 540 and/or host graphical display interface by use of a CSM manager 136, as disclosed herein. The CSM manager 136 may be configured to a) identify CSM pertaining to the composite application 140, b) determine the application(s) 126A-N to which the identified CSM should be directed, and c) direct the identified CSM to respective applications 126A-N. Directing the CSM to the respective applications 126A-N may comprise modifying the CSM by one or more of: formatting the CSM, translating the CSM, converting the CSM, splitting the CSM, and/or the like. Step 630 may further comprise identifying CSM pertaining to extended GUI elements 146 and, inter alia, issuing the CSM to respective applications 126A-N. Issuing the CSM may comprise adapting the CSM for use by CSM handlers 226A-N of the applications 126A-N, as disclosed above. Alternatively, or in addition, CSM pertaining to extended GUI elements 146, and/or selected native GUI elements 224A-N, may be handled by use of a CSM handler 246 of the composite application 140.

FIG. 7 is a flow diagram of another embodiment of a method 700 for managing a composite application 140. Step 710 may comprise executing a macro script 333 to initialize a composite application 140 by use of, inter alia, a macro engine 332. Step 710 may comprise executing an initialization macro script 533A of a composite application 540. Step 710 may include invoking a plurality of applications 126A-N by use of a process manager 132, forming a composite application interface 142 by use of the display manager 134, and displaying the composite application interface 142 on a display device of a computing system 101. Step 710 may further comprise issuing a plurality of CSM to the applications to place the applications into a particular state. The CSM issued in step 710 may be further adapted to configure the composite application interface 142, as disclosed herein.

Step 720 may comprise detecting a trigger condition associated with a second macro script 333 of the composite application 140 (e.g., macro script 533B). The trigger condition may be associated with an action 535B, as disclosed above. Step 720 may comprise detecting the trigger condition by use of the workflow manager 336. The workflow manager 336 may detect the trigger condition by use of an application integration manager 330, which may be configured to an application-specific interface of one or more of the applications 126A-N and/or an ACO 331A-N operating within one or more of the applications 126A-N. In one embodiment, the workflow manager 336 may be configured to periodically poll a presentation application 526A to determine whether a particular shape 544 is currently being displayed in a slide GUI area 524A[1] (e.g., determine the currently selected presentation slide).

Step 730 may comprise executing a second macro script 333 configured to embed a native GUI element 224A-N of a first application 126A-N into a second application 126A-N (e.g., in a composite application interface 152). In one embodiment, step 730 comprises embedding a visualization display area 526B[1] of the visualization application 526B into the native GUI interface 521 of the presentation application 526B. Step 730 may further include adapting the native GUI element 224A-N for use in the composite application 140, which may include conforming the visualization display area 526B[1] to a particular object and/or shape 544, as disclosed herein. Step 730 may be performed in response to detecting display of the shape 544 in step 720. In some embodiments step 730 further includes executing operations to put the applications 126A-N comprising the composite application 140 into a particular state (e.g., by, inter alia, adapting native GUI elements 224A-N of the application 126A-N, as disclosed herein). The operations may correspond to user inputs and/or events 202, which may have been recorded by use of the CSM recorder 334. The recorded inputs and/or events 202 may be stored in respective macro scripts 333 and/or actions 335, which may be replayed by use of the macro engine 332 and/or workflow manager 336, as disclosed herein.

Step 730 may further include handling CSM pertaining to the composite application 140, including CSM corresponding to native GUI elements 224A-N and/or extended GUI elements 146 of the composite application interface 142 by, inter alia, directing, modifying, formatting, translating, and/or splitting CSM pertaining to the composite application 140 for use by respective CSM handlers 226A-N of the applications 126A-N, as disclosed herein. Step 730 may include splitting a first CSM, such that the first CSM (and/or CSM corresponding thereto) is issued to two or more of the applications 126A-N. Alternatively, or in addition, step 730 may include capturing a CSM pertaining to a first application 126A-N and issuing the captured CSM to a second application 126A-N.

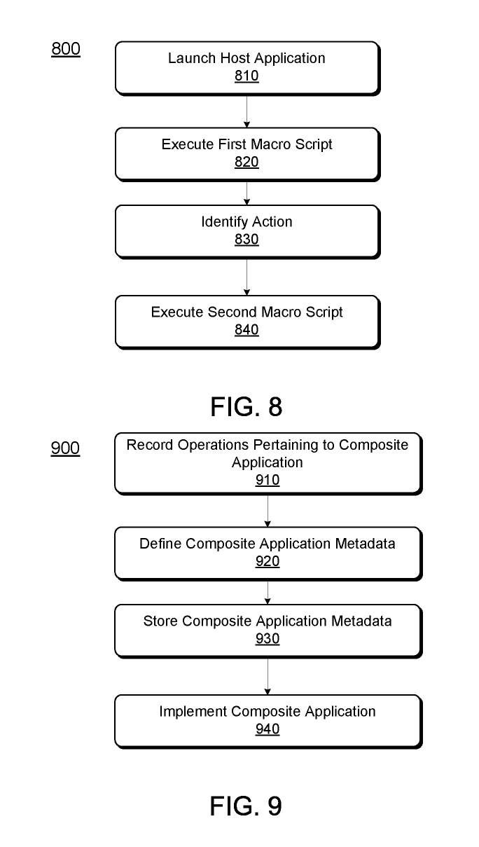

FIG. 8 is a flow diagram of another embodiment of a method 800 for managing a composite application. Step 810 comprises launching a host application 126A-N within an application framework 124 of a computing system 101. In one embodiment, the host application 126A-N comprises a presentation application 526A. The disclosure is not limited in this regard, however, and could be adapted to launch any suitable host application 126A-N within any suitable application framework 124 and/or operating environment 120.

Step 820 comprises issuing a sequence of CSM to the host application through the application framework 124 and/or operating environment 120 and by use of the macro engine 332. The CSM may be adapted to put the host application 126A-N into a particular state, configure native GUI elements 224A-N of the host application 126A-N, load custom GUI elements 146 into the host application 126A-N, and so on. The CSM issued in step 820 may correspond to a sequence of user inputs and/or events recorded by use of the CSM recorder 334. Accordingly, the CSM may be configured to emulate user interaction with the host application 126A-N. Alternatively, or in addition, the CSM may be specified programmatically, as disclosed herein.

Step 830 may comprise identifying an action 335 corresponding to the host application 126A-N (and/or composite application 140). In some embodiments, step 830 comprises detecting a trigger condition, as disclosed herein. Step 830 may comprise maintaining and/or monitoring application state metadata 131 pertaining to the host application 126A-N. Alternatively, or in addition, step 830 may comprise issuing queries to the host application 126A-N to determine whether one or more trigger conditions are satisfied (e.g., polling the host application 126A-N). Step 830 may include interacting with the host application 126A-N through an application-specific interface (using the application integration manager 330) and/or accessing an ACO 331A-N of the host application 126A-N. The trigger condition of step 830 may correspond to display of particular application objects, such as a shape 544 within a particular presentation slide. Detecting the trigger condition may comprise executing a macro script 333 associated with a particular action 335, such as macro script 533B associated with action 535B, as disclosed above. In response to detecting the trigger condition at step 830, the method 800 may continue at step 840. Otherwise, the method may continue monitoring the host application 126A-N at step 830.

Step 840 comprises executing a macro script 333 associated with the detected trigger condition (e.g., action 335). Step 840 may include one or more of: launching a child application 126A-N having a graphical user interface comprising a plurality of native graphical user interface elements 224A-N, such as the visualization application 526B, disclosed above. Step 840 may further include issuing a sequence of CSM to the child application 126A-N to put the child application 126A-N into a particular state, configure native GUI elements 224A-N of the child application 126A-N, and so on. The CSM may be configured to embed one of the native GUI elements of the child application 126A-N into the native GUI interface of the host application 126A-N. In one embodiment, step 840 comprises embedding a visualization display area 526B[1] of the visualization application 526B within the native GUI interface 521 of the host presentation application 526A. Embedding the native GUI elements 224A-N may further include adapting the native GUI elements 224A-N by one or more of scaling, positioning, cropping, morphing, performing image processing operations, and/or the like. In one embodiment, embedding the visualization display area 526B[1] comprises conforming the visualization display area 526B[1] to a particular shape 544 of the presentation application 526A.

In some embodiments, step 840 further includes displaying a composite application interface 142 including the host native GUI interface 521, native GUI elements 224A-N of the host application 526A and/or child application 526B, extended GUI elements 146, and/or the like, on a display device 106 of the computing system 101.

Set 850 may include managing the composite application 140 corresponding to the host application 126A-N and/or embedded child application 126A-N, which may include, but is not limited to: a) identifying CSM pertaining to the composite application 140, b) directing the CSM to respective application(s) 126A-N of the composite application 140, c) identifying trigger conditions pertaining to action(s) 335 of the composite application 140, d) executing macro scripts 333 in response to particular actions 335, and so on, as disclosed herein.

FIG. 9 is a flow diagram of another embodiment of a method 900 for managing a composite application. Step 910 may comprise recording operations pertaining to a composite application 140. Step 910 may include recording operations to initialize and/or manage a composite application 140, as disclosed herein. In some embodiments, step 910 includes a) recording CSM corresponding to user inputs and/or events 202 by use of a CSM recorder 334, b) specifying CSM programmatically, and/or the like. Step 910 may further include recording contextual information pertaining to the recorded operations, such as normalized application identifiers, user input and/or event timing, normalized pointer and/or input parameters, and so on. The operations recorded in step 910 may be configured for execution by the macro engine 332 to launch, configure, and/or manipulate a composite application 140 (and/or the application(s) 126A-N comprising the composite application 140). The operations of step 910 may define operations to a) launch one or more applications 126A-N (by use of the process manager 132), b) configure a composite application interface 142 that includes native GUI elements 224A-N of the applications 126A-N and/or extended GUI elements 146, c) specify modifications to the native GUI elements 224A-N, d) remove certain native GUI elements 224A-N, e) define CSM handling for the composite application 140, and so on, as disclosed herein.

Step 920 comprises defining composite application metadata 139 for the composite application 140, including the operations recorded at step 910. Step 920 may include defining macro scripts 333 and/or actions 335 corresponding to the operations recorded at step 910. As disclosed above, a macro script 333 may define a sequence of operations pertaining to a composite application 140. In some embodiments, the operations correspond to respective CSM captured and/or specified by a user in step 910. Step 920 may comprise arranging the operations of step 910 into a first macro script 333 (e.g., an initialization macro script 533A) configured to launch, initialize, and/or manipulate the composite application 140. Step 910 may further include associating the first macro script 333 with one or more actions 335 to trigger execution of the first macro script 333. Step 920 may further comprise arranging the CSM of step 910 into a second macro script 333 to implement a particular workflow, such the macro script 533B to embed a visualization display area 524B[1] of the child visualization application 526B into a shape 544 within a slide GUI area 524A[1] of the host presentation application 526B in FIGS. 5A-B. The second macro script 333 may be associated with an action 335 to trigger execution thereof, as disclosed herein. In one embodiment, an action 535B triggers execution of the macro script 533B in response to display of the shape 544 within the slide GUI area 524A[1] of the presentation application 526A.

Step 930 may comprise writing the composite application metadata 139 to a non-transitory computer readable storage medium, including the macro scripts 333 and/or actions 335. The macro scripts 333 and/or actions 335 may be stored as respective XML files, database entries, and/or the like. In some embodiments, the composite application metadata 139 are stored by use of the data structures illustrated in FIGS. 4A-B.

Step 940 comprises implementing a composite application 140 defined in the composite application metadata 139 by use of the GAC module 130, as disclosed herein. Step 940 may include executing one or more of the macro scripts 333 in response to detecting trigger conditions of one or more of the actions 335, by use of the macro engine 332 and/or workflow manager 336 of the GAC module 130. Step 940 may include a) launching application 126A-N on a computing system 101 and/or maintaining application state metadata 131 for the applications 126A-N by use of the process manager 132, b) forming a composite application interface 142 that includes native GUI elements 224A-N of the applications 126A-N and/or extended GUI elements 146 that are separate from the native GUI elements 224A-N of the applications 126A-N by use of the display manager 134, c) managing CSM pertaining to the composite application by use of the CSM manager 136, and so on, as disclosed herein.

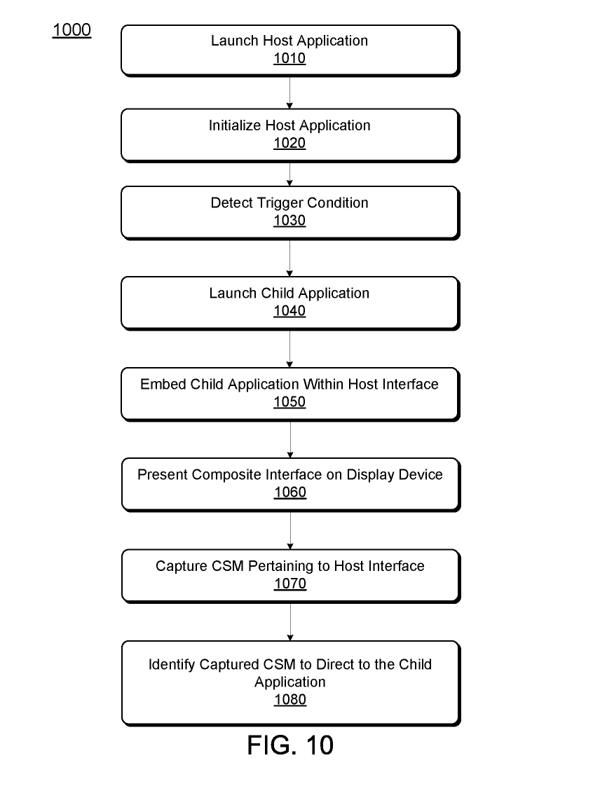

FIG. 10 is a flow diagram of another embodiment of a method 1000 for managing a composite application. In some embodiments, the operations of method 1000 are defined in composite application metadata 139. In one embodiment, the operations of steps 1010-1030 are defined in a first macro script 333 (e.g., an initialization macro script 533A), and the operations of steps 1040-1080 are defined in a second macro script 333 (e.g., macro script 533B). The macro scripts 333 may be associated with respective actions 335, as disclosed herein. The disclosure is not limited in this regard, however, and could be adapted to define the operations of method 1000 using any suitable data structure and/or data format.

Step 1010 comprises launching a host application 126A-N of a composite application 140 within an application framework 124 of a computing system. Step 1010 may comprise launching a presentation application 526A of a composite application 540.

Step 1020 comprises initializing the host application 126A-N by, inter alia, issuing CSM to the host application 126A-N to emulate user interaction with the host application 126A-N. Step 1020 may further include executing operations that do not correspond to user inputs and/or events 202, such as operations pertaining to an application-specific interface of the host application 126A-N and/or an ACO 331A-N of the host application 126A-N.

Step 1030 comprises detecting a trigger condition pertaining to the composite application 140. Step 1030 may comprise one or more of a) monitoring application state metadata 131 pertaining to the host application 126A-N, b) monitoring CSM pertaining to the host application 126A-N within the application framework 124, c) issuing queries through an application-specific interface, d) registering a callback of the host application 126A-N, and/or the like. In one embodiment, step 1030 comprises detecting display of a particular shape 544 within a presentation application 526A.

Step 1040 comprises launching a child application 126A-N. In one embodiment, step 1040 comprises launching a visualization application 526B. Step 1050 comprises embedding the child application 126A-N within the host application 126A-N. Step 1050 may include embedding a native GUI element 224A-N of the child application 126A-N into the composite application interface 142. In one embodiment, step 1050 comprises embedding a visualization display area 524B[1] within a slide GUI area 524A[1] of the host presentation application 526A. Embedding may further include adapting the native GUI area 224A-N for use in the composite application interface 142. In one embodiment, embedding the visualization display area 524B[1] includes fitting the visualization display area 524B[1] to a shape 544 within a slide of the host presentation application 526A.Step 1050 may further include configuring the child application 126A-N by, inter alia, issuing CSM to the child application 126A-N to place the child application 126A-N in a particular state, as disclosed herein. Step 1060 comprises displaying the composite application interface 142, including the child application 126A-N embedded within the host application 126A-N on a display device 106 of the computing system 101, as disclosed herein.

Step 1070 comprises capturing CSM pertaining to an interface of the host application 126A-N. In one embodiment, step 1070 comprises capturing CSM pertaining to a native GUI interface 521 of the host presentation application 526A. Step 1080 comprises identifying captured CSM to direct to the child application. In one embodiment, step 1080 includes determining whether a particular CSM pertains to the child application 126A-N based on characteristics of the CSM (e.g., pointer position, focus, and/or the like). Step 1080 may include adapting the CSM for use by the child application 126A-N, which may include one or more of: translating the CSM, formatting the CSM, converting the CSM, splitting the CSM (e.g., issuing the CSM to two or more different applications 126A-N), and/or the like.

While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

Moreover, one of ordinary skill in the art will appreciate that various modifications and changes can be made without departing from the scope of the present disclosure and that other uses for the described systems and methods are possible. Accordingly, this disclosure is to be regarded in an illustrative rather than a restrictive sense, and all such modifications and uses are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. The scope of the present invention should, therefore, be determined by the following claims.

We claim:

1. An apparatus, comprising:
a process management circuit configured to launch a plurality of applications within an operating environment of a computing device, the plurality of processes including a host application and a child application, wherein the host application comprises a host graphical display interface, and wherein the child application comprises a plurality of child graphical display elements;
a display management circuit configured to embed a first one of the plurality of child graphical display elements within the host graphical display interface; and
an event handler circuit to redirect an input associated with the host graphical display interface to the child application.

2. The apparatus of claim 1, wherein the display management circuit is configured to remove one or more of the plurality of child graphical display elements.

3. The apparatus of claim 1, further comprising an application integration module to identify an object within the host graphical display interface, wherein the display management circuit is configured to embed the first child graphical display element within the identified object.

4. The apparatus of claim 3, wherein embedding the first child graphical display element comprises fitting the first graphical display element to the object within the host graphical display interface.

5. The apparatus of claim 4, wherein fitting the first graphical display element comprises one or more of cropping the first graphical display element, scaling the first graphical display element, positioning the first graphical display element, and morphing the first graphical display element.

6. The apparatus of claim 1, wherein the display management circuit is configured to embed an extended graphical display element within the host graphical display interface that is separate from graphical display elements of the host application and from the plurality of child graphical display elements.

7. The apparatus of claim 6, wherein the event handler circuit is configured to direct a message pertaining to the extended graphical display element to one or more of the host application and the child application.

8. The apparatus of claim 6, wherein the event handler circuit is configured to capture a message pertaining to one of a graphical interface element of the host application, a graphical interface element of the child application, and the extended graphical interface element and to issue a corresponding message to both the host application and the child application.

9. The apparatus of claim 8, wherein issuing the corresponding message to the host application comprises one of formatting the message and translating the message for use by an event handler of the host application.

10. A system, comprising:
a computing system comprising a display device and a user input device;
a macro engine to execute a first macro script associated with a composite application on the computing system, wherein executing the first macro script comprises:
invoking a plurality of applications by use of an application framework of the computing system,
forming a graphical user interface of the composite application by use of native graphical user interface elements of the plurality of applications,
displaying the graphical user interface of the composite application on the display device of the computing system, and
issuing a plurality of computer system messages to the plurality of applications by use of the application framework, wherein the computer system messages are configured to place the plurality of applications into a particular state; and
a workflow manager to configure the macro engine to execute a second macro script associated with the composite application in response to a trigger condition associated with the second macro script, wherein executing the second macro script comprises embedding a native graphical user interface element of a first one of the applications into a native graphical user interface element of a second one of the applications.

11. The system of claim 10, further comprising an application integration module to detect the trigger condition associated with the second macro script by use of an application-specific interface of the second application.

12. The system of claim 11, wherein the application integration module detects the trigger condition by use of an application coordination object of the second application.

13. The system of claim 11, wherein the trigger condition corresponds to display of a particular shape within the native graphical user interface element of the second application.

14. The system of claim 13, wherein executing the second macro script comprises adapting the native graphical user interface element of the first application in accordance with the particular shape within the native graphical user interface element of the second application.

15. The system of claim 10, further comprising a recorder module to capture computer system messages configured to place the plurality of applications into the particular state in response to manipulation of the user input device of the computing system.

16. The system of claim 10, further comprising a computer system message handler to direct computer system messages pertaining to the composite application to one or more of the plurality of applications.

17. The system of claim 16, wherein the computer system message handler is configured to split a first message, such that the first message is issued to two or more of the plurality of applications.

18. The system of claim 16, wherein the computer system message handler is configured to capture a message pertaining to a first one of the plurality of applications and to issue the captured message to a second one of the plurality of applications.

19. A method, comprising:
launching a host application within an application framework of a computing system, the host application having a host graphical user interface;
issuing a sequence of computer system messages to the host application through the application framework, wherein the sequence of computer system messages is configured to emulate user interaction with the host application; and
in response to detecting a trigger condition pertaining to the host application;
launching a child application on the computing system, the child application having a child graphical user interface comprising a plurality of native graphical user interface elements,
issuing a sequence of computer system messages to the child application through the application framework, wherein the sequence of computer system messages is configured to embed one of the native graphical user interface elements of the child application into the host graphical user interface,
displaying a composite application interface comprising the native graphical user interface of the child application embedded within the host graphical user interface on a display device of the computing system,
capturing messages corresponding to the host graphical user interface, and
identifying captured messages to direct to the child application.

20. The method of claim 19, further comprising:
embedding an extended graphical user interface element within the host graphical user interface, wherein the extended graphical user interface element is separate from native graphical user interface elements of the host application and the native graphical user interface elements of the child application;
capturing messages pertaining to the extended graphical user interface element; and
forwarding the captured messages pertaining to the extended graphical user interface element to one or more of the host application and the child application.
